(19) United States
(12) Patent Application Publication
(10) Pub. No.: US 2016/0134013 A1
(43) Pub. Date: May 12, 2016

(54) ANTENNA DEVICE

(71) Applicant: Asahi Glass Company, Limited, Chiyoda-ku (JP)

(72) Inventors: Kotaro SUENAGA, Chiyoda-ku (JP); Osamu KAGAYA, Chiyoda-ku (JP); Koji IKAWA, Chiyoda-ku (JP)

(73) Assignee: Asahi Glass Company, Limited, Chiyoda-ku (JP)

(21) Appl. No.: 15/001,456

(22) Filed: Jan. 20, 2016

Related U.S. Application Data
(63) Continuation of application No. PCT/JP2014/069960, filed on Jul. 29, 2014.

(30) Foreign Application Priority Data
Aug. 5, 2013 (JP) 2013-162639

(51) Int. Cl. H01Q 1/52; H01Q 1/12

(52) U.S. Cl. CPC H01Q 1/521; H01Q 1/1271

(57) ABSTRACT

An antenna device includes a first antenna conductor having a first feeding point provided on windshield glass, a second antenna conductor having a second feeding point, a passive conductor, and an auxiliary conductor, wherein the first antenna conductor and the second antenna conductor are arranged in a vicinity of the auxiliary conductor with a predetermined gap therebetween, the passive conductor includes a first passive element extending in a direction away from the auxiliary conductor, and a second passive element connected to one end of the first passive element on a side of the auxiliary conductor and extending along the auxiliary conductor, and an open end of the second passive element is arranged at a position on a side of the first antenna conductor, and adjacent to the auxiliary conductor between the first antenna conductor and the second antenna conductor.

### CROSS-REFERENCE TO RELATED APPLICATIONS

This application is a continuation application filed under 35 U.S.C. 111(a) claiming the benefit under 35 U.S.C. 120 and 365(c) of a PCT International Application No. PCT/JP2014/069960 filed on Jul. 29, 2014, which is based upon and claims the benefit of priority of Japanese Patent Application No. 2013-162639 filed on Aug. 5, 2013, the entire contents of which are incorporated herein by reference.

### BACKGROUND OF THE INVENTION

1. Field of the Invention

The present invention relates to an antenna device for automotive glass.

2. Description of the Related Art

Conventionally, an antenna glass for automotive glass has been proposed for receiving digital terrestrial television broadcasting bands. For example, Japanese Laid-Open Patent Publication No. 2008-22538 proposes an antenna that can obtain a high gain in a broadband broadcasting frequency band such as the digital terrestrial television broadcast.

Recently, an ITS (Intelligent Transport System) utilizing radio waves in the 700 MHz band, adjacent to the digital terrestrial television broadcasting band, is under study. However, in a case in which an antenna for ITS transmission and reception is provided as a glass antenna on automotive windshield glass, media having close frequency bands such as the ITS and the digital terrestrial television broadcast may easily interfere with each other in a limited region of the automotive windshield glass. Hence, arrangements of the antennas require consideration.

For example, Japanese Laid-Open Patent Publication No. 2000-174529 proposes reducing interference between antenna elements by providing a passive conductor (parasitic conductor).

With regard to the interference between two antenna elements, in a case in which two antenna elements are arranged in a vicinity of a flange on a roof side at a window opening of a vehicle, for example, interference caused by an excitation current generated at the flange on the roof side occurs in addition to spatial interference between the antenna elements. However, the Japanese Laid-Open Patent Publication No. 2000-174529 cannot obtain a sufficient interference reducing effect with respect to the interferences caused by the same adjacent conductor.

### SUMMARY OF THE INVENTION

Accordingly, one object of the present invention is to provide an antenna device which can reduce mutual interference in a case in which two antenna elements are arranged adjacent to the same conductor, such as the roof or the like.

According to one aspect of the present invention, an antenna device includes a first antenna conductor having a first feeding point provided on windshield glass, a second antenna conductor having a second feeding point, a passive conductor, and an auxiliary conductor, wherein the first antenna conductor and the second antenna conductor are arranged in a vicinity of the auxiliary conductor with a predetermined gap therebetween, the passive conductor includes a first passive element extending in a direction away from the auxiliary conductor, and a second passive element connected to one end of the first passive element on a side of the auxiliary conductor and extending along the auxiliary conductor, and in a case in which the windshield glass is segmented into two regions by an imaginary segmenting line passing through the first passive element between the first antenna conductor and the second antenna conductor, an open end of the second passive element is arranged at a position on a side of the first antenna conductor, and adjacent to the auxiliary conductor between the first antenna conductor and the second antenna conductor.

Other objects and further features of the present invention will be apparent from the following detailed description when read in conjunction with the accompanying drawings.

### BRIEF DESCRIPTION OF THE DRAWINGS

FIG. 1A is a plan view illustrating an antenna device in a first embodiment in a case in which a roof 106 is regarded as a horizontal conductor and a pillar 105 is regarded as a vertical conductor;

FIG. 1B is a plan view illustrating the antenna device in the first embodiment in a case in which the roof 106 is regarded as the horizontal conductor and a conductor 108v is regarded as the vertical conductor;

FIG. 1C is a plan view illustrating the antenna device in the first embodiment in a case in which a conductor 108h is regarded as the horizontal conductor and the conductor 108v is regarded as the vertical conductor;

FIG. 1D is a plan view illustrating the antenna device in the first embodiment in a case in which the roof 106 is regarded as the horizontal conductor and the pillar 105 and a conductor 110 are regarded as the vertical conductor;

FIG. 2A is a plan view of the antenna device in the first embodiment arranged in a horizontal direction and provided with an L-shaped passive conductor;

FIG. 2B is a plan view illustrating a modification of the L-shaped passive conductor;

FIG. 2C is a plan view of the antenna device in the first embodiment arranged in a vertical direction and provided with the L-shaped passive conductor;

FIG. 3 is a plan view of the antenna device in the first embodiment provided with a T-shaped passive conductor;

FIG. 4 is a plan view of the antenna device in the first embodiment provided with a linear passive conductor;

FIG. 5 is a plan view illustrating one example of a first antenna conductor in the first embodiment;

FIG. 6 is a plan view illustrating one example of the first antenna conductor in the first embodiment;

FIG. 7 is a plan view illustrating one example of the first antenna conductor in the first embodiment;

FIG. 8 is a plan view illustrating the antenna device in a second embodiment;

FIG. 9 is a plan view illustrating the antenna device in a third embodiment;

FIG. 10 is a plan view illustrating the antenna device in a fourth embodiment;

FIG. 11 is a diagram illustrating a relationship between an overall length of the passive conductor and S21;

FIG. 12 is a diagram illustrating a relationship between an aspect ratio of the passive conductor and S21;

FIG. 13 is a diagram illustrating a relationship between an X-direction position of the passive conductor and S21;

FIG. 14 is a diagram illustrating a relationship between a gap of a first antenna conductor and a second antenna conductor and S21;

FIG. 15 is a diagram illustrating a relationship between a Y-direction position of the passive conductor and S21; and

FIG. 16 is a diagram illustrating a relationship between the X-direction position of the first antenna conductor and S21.

### DESCRIPTION OF THE PREFERRED EMBODIMENTS

A description will hereinafter be given of embodiments of the present invention with reference to the drawings. In the drawings used to describe the embodiments, parallel lines, perpendicular lines, curvatures of corner parts, or the like may tolerate an error to a certain extent that does not impair the effects of the embodiments. In addition, the drawings illustrate automotive windshield glass 102 which will be described later, in a state mounted on a vehicle and viewed from inside the vehicle, however, the drawings may be referred to as illustrating the state viewed from outside the vehicle. Further, in the drawings, right and left directions correspond to a direction along a width of the vehicle, and will be referred to as a horizontal direction. Moreover, in the drawings, up and down directions correspond to a direction along a height of the vehicle, and will be referred to as a vertical direction. In the following description, coordinates are defined by arrows at a lower left of the drawings, and a reference is made to the coordinates where necessary.

In addition, in the following embodiments, an antenna for ITS having a center frequency of 760 MHz and an antenna for the digital terrestrial television broadcast having an upper limit value of 710 MHz for the reception frequency are regarded as examples of antennas transmitting or receiving media having close frequency bands that may easily interfere with each other. However, the media to which the antenna device may be applied are not limited to these media.

### First Embodiment

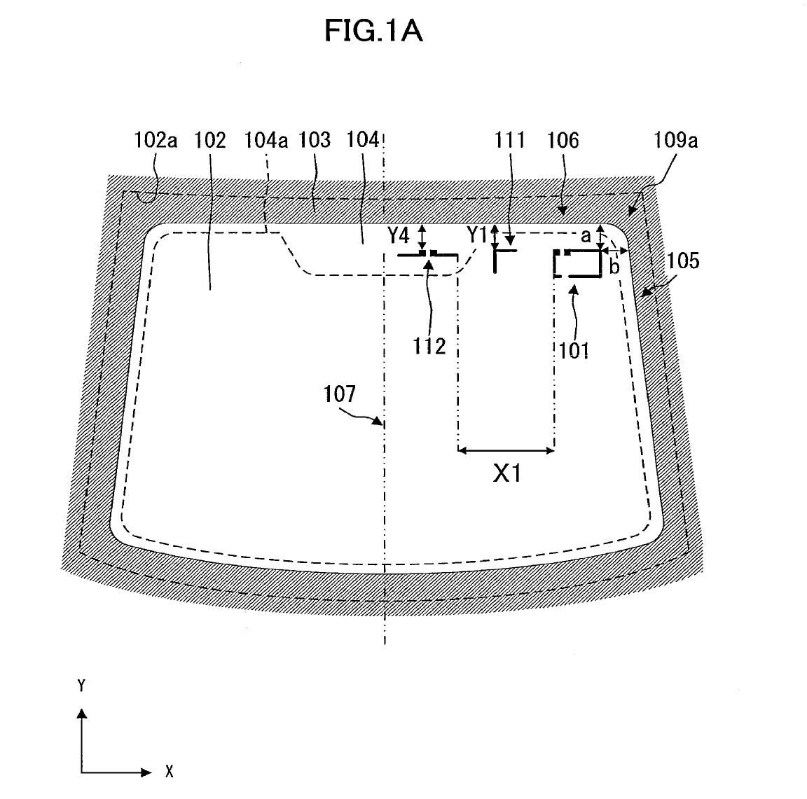

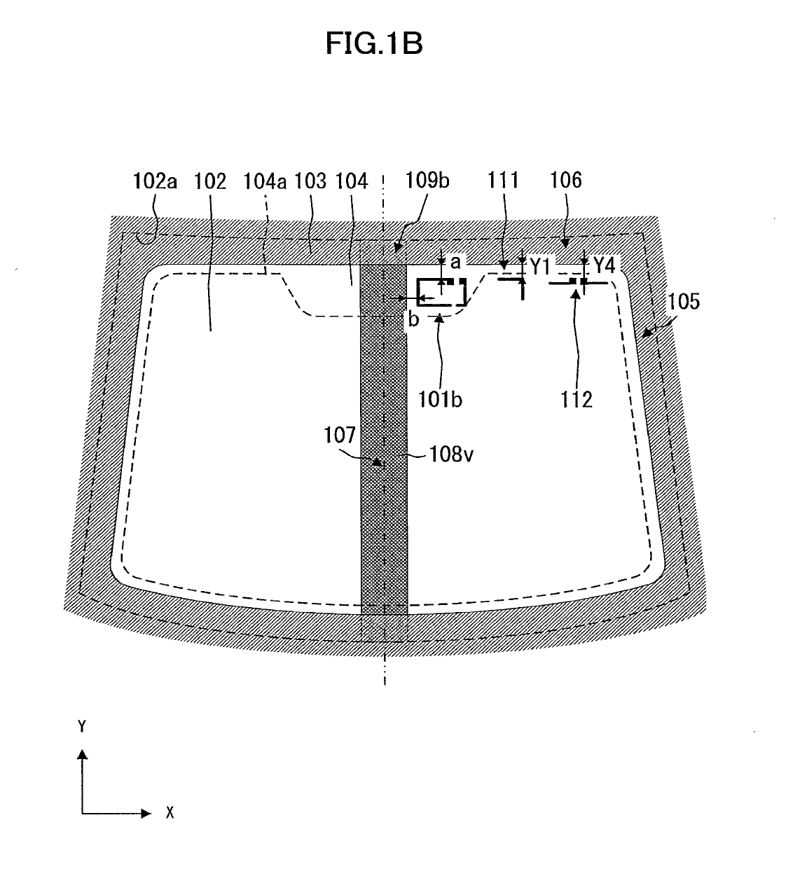

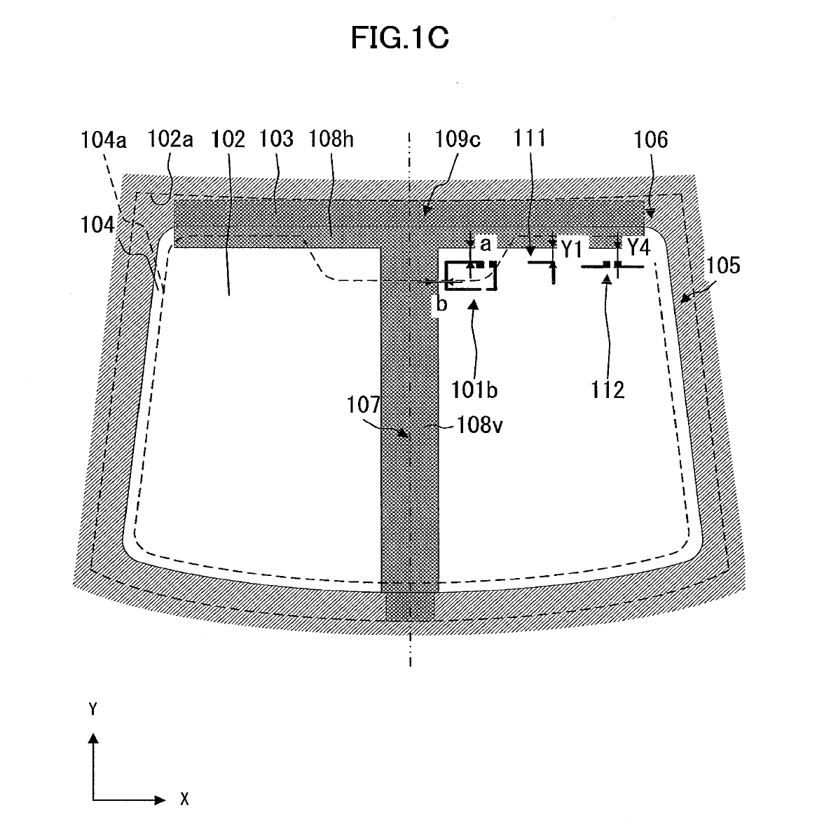

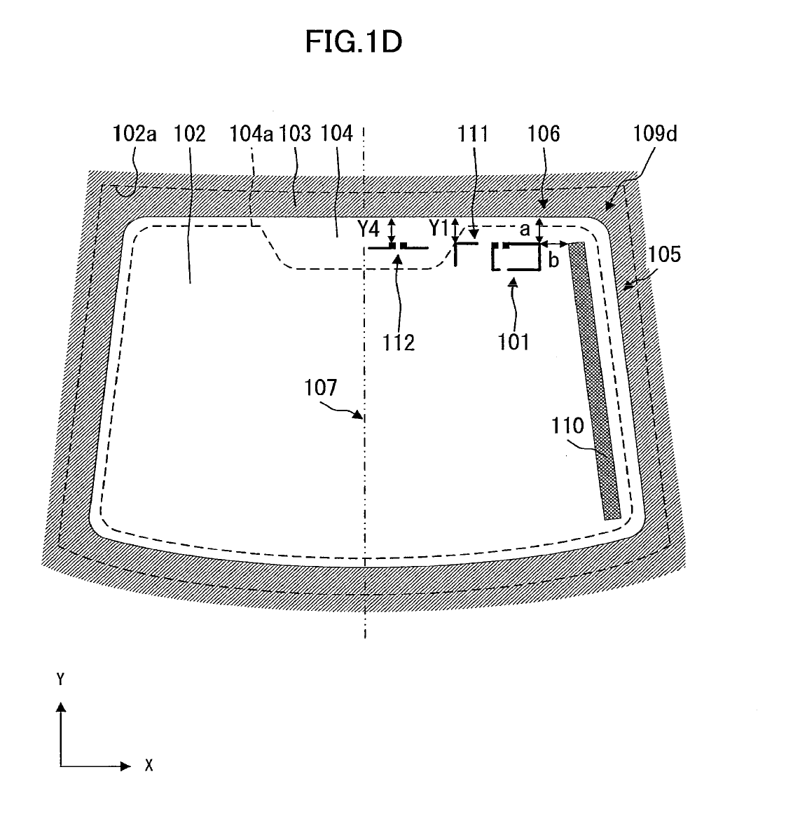

FIGS. 1A, 1B, 1C, and 1D (hereinafter also referred collectively as “FIG. 1”) illustrate plan views of the antenna device in a first embodiment of the present invention. In FIG. 1, the automotive windshield glass 102 is illustrated in a state mounted on the vehicle and viewed from inside the vehicle. The automotive windshield glass 102 is provided on a metal flange 103 that forms a windshield opening of a vehicle body. In addition, the automotive windshield glass 102 is provided with a black concealing layer 104 in a region having a predetermined width from an outer edge 102a of the automotive windshield glass 102, in order to conceal a bonding part with respect to the metal flange 103 of the vehicle body, from a viewpoint of preventing deterioration of an adhesive and from a viewpoint of providing beautiful appearance. The black concealing layer 104 is provided between the outer edge 102a of the automotive windshield glass 102 and an edge part 104a of the black concealing layer 104, as illustrated in FIG. 1. Although FIG. 1 illustrates an example in which the black concealing layer 104 is provided, the black concealing layer 104 may be omitted if unnecessary.

The antenna device in this embodiment includes a first antenna conductor 101 provided on the automotive windshield glass 102, a first feeding point provided on the first antenna conductor and including a first feeding part and a second feeding part that are arranged adjacent to each other, a second antenna conductor 112, a second feeding point provided on the second antenna conductor 112 and a passive conductor 111, and an auxiliary conductor. In the first embodiment, the first antenna conductor is described as an interfering side antenna on the right side in FIG. 1, and the second antenna conductor 112 is described as an interfered side antenna on the left side in FIG. 1. However, the first antenna conductor and the second antenna conductor are not limited to such antennas. In other words, the first antenna conductor may refer to the interfered side antenna on the left side in FIG. 1, or to the interfering side antenna on the left side in FIG. 1.

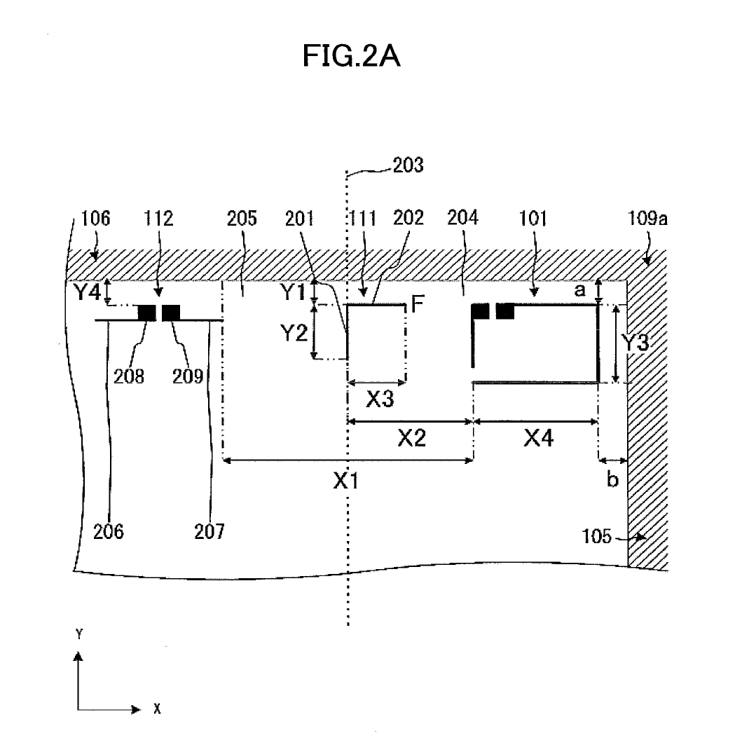

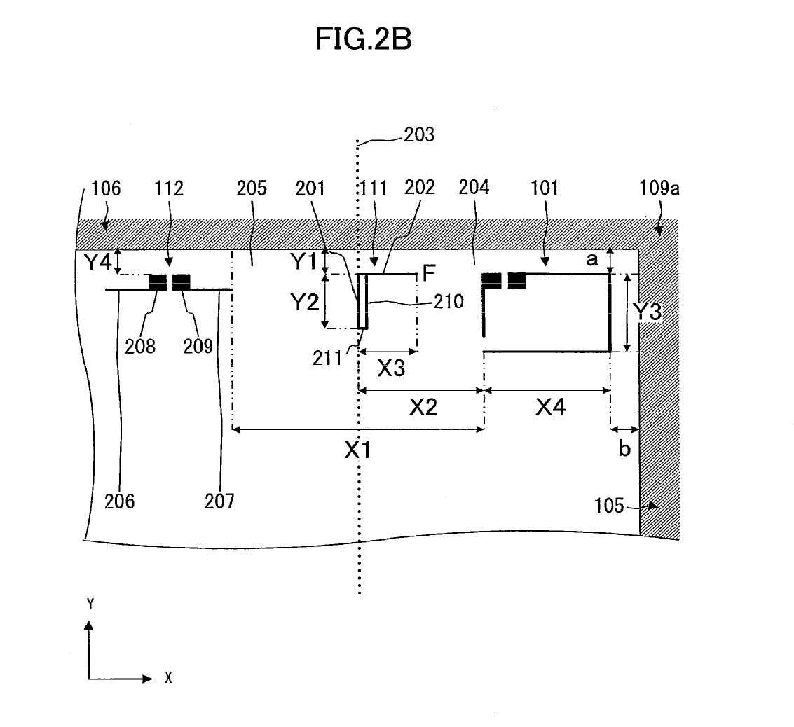

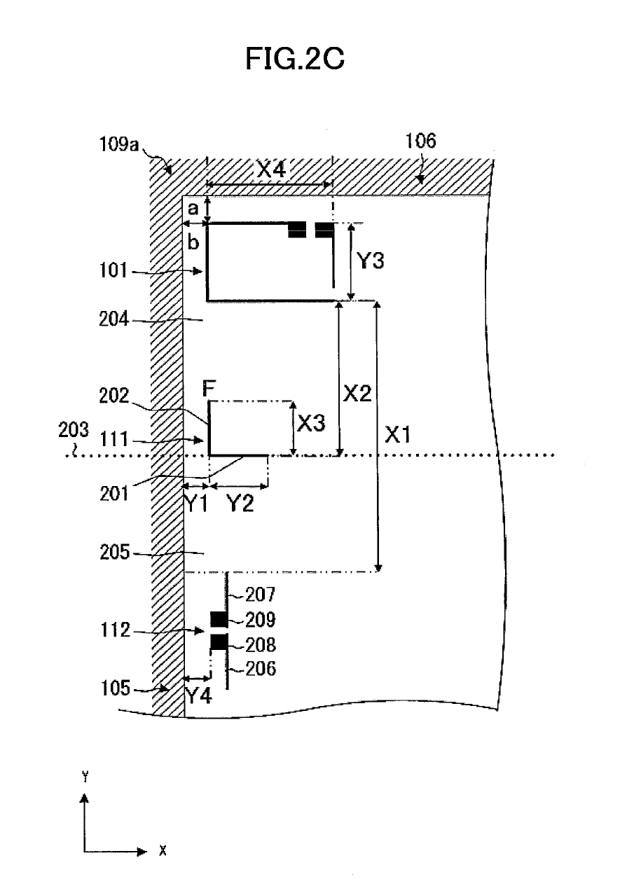

The auxiliary conductor includes at least one of a horizontal conductor provided linearly in the horizontal direction, and a vertical conductor electrically connected to the horizontal conductor and provided linearly in the vertical direction. In the first embodiment, the auxiliary conductor includes both the horizontal conductor and the vertical conductor, and the horizontal conductor and the vertical conductor form a T-shape, an L-shape, or a cross shape. The feeding point and the auxiliary conductor will be described later in more detail in conjunction with FIG. 2 and the subsequent figures.

The first antenna conductor 101 is regarded as the antenna for making the ITS transmission and reception, and is provided in a vicinity of a connecting part of the horizontal conductor and the vertical connector. The first feeding point is located at a part along the horizontal conductor of the antenna conductor. The vicinity of the connecting part refers to the vicinity of the connecting part where the horizontal conductor and the vertical conductor overlap in the plan view. A distance a (hereinafter referred to as “distance a between the first antenna conductor and the horizontal conductor”) between the horizontal conductor and a part of the first antenna conductor 101 closest to the horizontal conductor is desirably 70 mm or less, and a distance b (hereinafter referred to as “distance b from the vertical conductor”) between the vertical conductor and a part of the antenna conductor 101 closest to the vertical conductor is desirably 50 mm or less, from a viewpoint of improving a receiving sensitivity of vertical polarized waves. The reason the first antenna conductor 101 is provided in the vicinity of the connecting part is to transmit and receive the vertical polarized waves by the first antenna conductor. In a case in which horizontal polarized waves are transmitted and received by the first antenna conductor 101, the first antenna conductor 101 may be provided in a vicinity of only the horizontal conductor or in a vicinity of only the vertical conductor, instead of the vicinity of the connecting part.

The second antenna conductor 112 is regarded as the antenna for receiving the digital terrestrial television broadcast, and is provided at a predetermined gap from the first antenna conductor 101. The predetermined gap refers to a distance between parts of the first antenna conductor and the second antenna conductor that are closest to each other, and is preferably in a range of 150 mm or greater than less than 250 mm in order to obtain a large interference reducing effect. The second antenna conductor 112 is arranged on an opposite side (direction away from the vertical conductor) from the vertical conductor that is adjacent to the first antenna conductor 101. In addition, the second antenna conductor 112 is provided to be adjacent to the horizontal conductor.

As will be described later, the first antenna conductor is an antenna that generates an excitation current in the roof 106 and causes this current to flow through the roof 106. When the first antenna conductor 101 and the second antenna conductor 112 are arranged adjacent to the same horizontal conductor, such as the roof 106, the excitation current generated in the roof 106 by the first antenna conductor 101 flows to the second antenna conductor 112 through the roof 106 and affects the second antenna conductor. In other words, the first antenna conductor 101 and the second antenna conductor 112 are affected by both spatial interference transmitted on the glass surface and interference transmitted through the roof 106.

A passive conductor 111 is provided between the first antenna conductor 101 and the second antenna conductor 112. In addition, the passive conductor 111 is preferably arranged at a position where a distance Y1 (hereinafter referred to as “distance Y1 between the passive conductor and the horizontal conductor”) between the horizontal conductor and a part of the passive conductor 111 closest to the horizontal conductor is 30 mm or less, in order to obtain the large interference reducing effect.

FIGS. 1A, 1B, 1C, and 1D illustrate embodiments of a positional relationship of the first antenna conductor 101, the second antenna conductor 112, the passive conductor 111, the horizontal conductor, and the vertical conductor. The horizontal conductor in this embodiment tolerates a horizontal error to a certain extent that does not impair the effects of this embodiment, and may have a curvature along the shape of a flange on the roof side, particularly at the windshield opening of the vehicle body where the automotive windshield glass 102 is provided. In addition, the vertical conductor in this embodiment tolerates a vertical error to a certain extent that does not impair the effects of this embodiment, and may be provided at an inclination along the shape of a flange on the pillar side, particularly at the windshield opening of the vehicle body where the automotive windshield glass 102 is provided.

In FIG. 1A, the first antenna conductor 101 is arranged in a vicinity of a connecting part 109a where a roof side flange 106 forming an upper side of the metal flange 103 of the vehicle and a pillar side flange 105 forming a side of the metal flange 103 of the vehicle connect at a predetermined angle. In the following description of the drawings, the side of the metal flange 103 will be referred to as the pillar 105, and the upper side of the metal flange 106 will be referred to as the roof 106. In the embodiment of FIG. 1A, the roof 106 corresponds to the horizontal conductor, and the pillar 105 corresponds to the vertical conductor, respectively. In a case in which the pillar 105 is provided at a predetermined angle greater than the perpendicular angle, the distance b from the vertical conductor of the first antenna conductor 101 corresponds to a distance from an upper right end part of the first antenna conductor 101 to the pillar 105.

The passive conductor 111 is arranged between the first antenna conductor 101 and the second antenna conductor 112, and is separated by the distance Y1 from the roof 106. In FIG. 1A, the distance a between the first antenna conductor and the horizontal conductor and the distance Y1 between the passive conductor and the horizontal conductor have the same length along the Y-direction, however, the distances are not limited to those of this embodiment. In other words, the passive conductor may further be adjacent to the roof 106.

The second antenna conductor 112 is provided at a position separated by a distance X1 from the first antenna conductor 101. X1 refers to the distance between a part of the second antenna conductor 112 closest to the first antenna conductor 101, and a part of the first antenna conductor 101 closest to the second antenna conductor 112. In a case in which X1 is small, the second antenna conductor 112 easily receives interference because the effects from the first antenna conductor 101 is large, and the second antenna conductor 112 does not easily receive the interference in a case in which X1 is large. In addition, the second antenna conductor 112 is provided at a position separated by a distance Y4 from the roof 106. Y4 refers to a minimum distance between the second antenna conductor 112 and the roof 106. In a case in which Y4 is small, the second antenna conductor 112 easily receives interference from the first antenna conductor 101 transmitted through the roof 106, and the second antenna conductor 112 does not easily receive the interference in a case in which Y4 is large.

In FIG. 1B, an antenna conductor (hereinafter referred to as “first antenna conductor 101b”) having a pattern that is a mirror image (line symmetric with respect to a Y-direction axis) of the first antenna conductor 101 of FIG. 1A along an X-direction is arranged in a vicinity of a connecting part 109b that connects to a conductor 108v provided on a centerline 107 extending in the up and down directions and passing through the roof 106 and a center of gravity of the automotive windshield glass 102. The roof 106 corresponds to the horizontal conductor, and the conductor 108v corresponds to the vertical conductor, respectively.

In the case of laminated glass having a first glass plate and a second glass plate that are laminated via an intermediate layer, the conductor 108v may be provided on the intermediate layer of the laminated glass, or may be provided on a surface of one of the two glass plates. The configuration in which the conductor 108v is provided on the intermediate layer may have the conductor 108v provided on the intermediate layer itself of the laminated glass, or may have the conductor 108v that is separate from the intermediate layer sandwiched between the two glass plates. In addition, the surface of one of the two glass plates may be an inner surface or an outer surface of each of the two glass plates of the laminated glass. It is particularly preferable that the conductor 108v is formed by a transparent conductor layer.

In addition, in the connecting part 109b, the roof 106 and the conductor 108v are electrically connected. The electrical connection may be either one of an AC coupling or a DC coupling, however, the DC coupling is particularly preferable. The AC coupling refers to a state in which, in the connecting part 109b, for example, the roof 106 and the conductor 108v are capacitively coupled in a direction of a thickness of the automotive windshield glass 102 or on the same plane, via an insulator. In the case of the capacitive coupling in the direction of the thickness, the roof 106 and the conductor 108v may overlap at the connecting part 109h. In the case of the capacitive coupling on the same plane, the roof 106 and the conductor 108v may be separated at the connecting part 109b.

A length of the conductor 108v in the Y-direction is desirably long compared to a wavelength of the radio waves used for the transmission and reception, and the conductor 108v does not need to be provided for the entire length from the upper end to the lower end of the automotive windshield glass 102. In addition, the length of the conductor 108v in the X-direction is not limited to a particular value and may be set in a current capacity range in which the vertical polarized waves are obtainable, and is desirably short compared to the wavelength of the radio waves used for the transmission and reception.

FIG. 1C illustrates an example in which a conductor 108h is arranged in the horizontal direction, in addition to the configuration of FIG. 1B. The first antenna conductor 101b is arranged in a vicinity of a connecting part 109c between the conductor 108h and the conductor 108v. In this case, the conductor 108h corresponds to the horizontal conductor, and the conductor 108v corresponds to the vertical conductor, respectively. In the case of the laminated glass having the first glass plate and the second glass plate that are laminated via the intermediate layer, the conductor 108h may be provided on the intermediate layer of the laminated glass, or may be provided on the surface of one of the two glass plates. It is particularly preferable that the conductor 108h and the conductor 108v are formed by a transparent conductor layer. The conductor 108h and the conductor 108v do not necessarily need to have the same configuration, and for example, the conductor 108h may be provided on the intermediate layer and the conductor 108v may be provided on the surface of one of the two glass plates, or vice versa.

In the connecting part 109c, the conductor 108h and the conductor 108v are electrically connected. The electrical connection may be either one of the AC coupling or the DC coupling, however, the DC coupling is particularly preferable. The AC coupling refers to a state in which, in the connecting part 109c, for example, the conductor 108h and the conductor 108v are capacitively coupled in the direction of the thickness of the automotive windshield glass 102 or on the same plane, via the insulator. In the case of the capacitive coupling in the direction of the thickness, the conductor 108h and the conductor 108v may overlap at the connecting part 109c. In the case of the capacitive coupling on the same plane, the conductor 108h and the conductor 108v may be separated at the connecting part 109c.

In FIG. 1C, the conductor 108v and the conductor 108h connect to form a T-shape, however, the configuration is not limited to that illustrated in FIG. 1C. For example, the conductor 108v and the conductor 108h may connect to form an L-shape or a cross shape. In addition, in a case in which a conductor other than the roof 106 is regarded as the horizontal conductor, as in this embodiment, the conductor 108h is preferably electrically connected to the roof 106 from a viewpoint of improving an antenna gain. When the conductor 108h and the roof 106 are in a positional relationship to electrically connect to each other, a roof-feeding becomes possible with respect to the antenna conductor 101.

In the passive conductor 111 and the second antenna conductor 112, in the case of the configuration in which the conductor 108h is provided on the in-plane side of the roof 106 as illustrated in FIG. 1C, the distance Y1 is the distance between the passive conductor 111 and the conductor 108h. In a case in which the conductor 108h does not extend to the upper parts of the passive conductor 111 and the second antenna 112, Y1 and Y4 becomes the minimum distance to the closer one of the roof 106 and the conductor 108h.

FIG. 1D illustrates an example in which the conductor 110 is arranged on the glass surface on the inner side of the pillar 105. The first antenna conductor 101 is arranged in a vicinity of a connecting part 109d between the roof 106 and the pillar 105. In this case, the roof 106 corresponds to the horizontal conductor, and because the pillar 105 and the conductor 110 are electrically connected, the pillar 105 and the conductor 110 as a whole corresponds to the vertical conductor, respectively. In the case of laminated glass having the first glass plate and the second glass plate that are laminated via the intermediate layer, the conductor 110 may be provided on the intermediate layer of the laminated glass, or may be provided on the surface of one of the two glass plates. The conductor 110 may be a transparent conductor layer, or may be a heater wire, a bus bar, or the like for snow removal or defrosting, formed by a metal film such as a copper film, or a sintered body of conductor paste.

In addition, as illustrated in FIG. 1D, in a case in which the roof 106 and the pillar 105 are electrically connected, and the conductor 110 is sufficiently capacitively coupled to the pillar 105, the conductor 110 and the roof 106 are indirectly electrically connected. Accordingly, even when the conductor 110 is not directly electrically connected to the roof 106, the conductor 110 may be regarded as a part of the vertical conductor. The length of the conductor 110 in the Y-direction is desirably long compared to the wavelength of the radio waves used for transmission and reception. In addition, the length of the conductor 110 in the X-direction is not limited to a particular value and may be set in a range in which the vertical polarized waves are obtainable, and is desirably short compared to the wavelength of the radio waves used for the transmission and reception.

In this embodiment, the first antenna conductor 101 is provided in-plane at the upper right of the automotive windshield glass 102, however, the location of the first antenna conductor 101 is not limited to that of this embodiment. The first antenna conductor 101b may be provided at a symmetrical position, using as an axis of symmetry, the centerline 107 extending in the up and down directions and passing through the center of gravity of the automotive windshield glass 102.

FIG. 2A is a plan view, on an enlarged scale, of the antenna device in the first embodiment having the first antenna conductor 101 of FIG. 1A arranged in a vicinity of the connecting part 109a connecting the roof 106 (horizontal conductor) that is the auxiliary conductor and the pillar 105 (vertical conductor) forming the side at a predetermined angle. In FIG. 2A, the illustration of the black concealing layer 104 is omitted in order to avoid the figure from becoming complex. In addition, it is assumed that the pillar 105 and the roof 106 intersect perpendicularly.

As illustrated in FIG. 2A, the passive conductor 111 includes a first passive element 201 extending in a direction away from the horizontal conductor, and a second passive element 202 connecting to one end of the first passive element 201 on the horizontal conductor side and extending along the horizontal conductor. In this embodiment, the passive conductor 111 forms an L-shape. By providing this passive conductor 111 between the first antenna conductor 101 and the second antenna conductor 112, it is possible to reduce both the interference from the first antenna conductor 101 transmitted to the second antenna conductor 112 on the glass surface and the interference from the first antenna conductor 101 transmitted to the second antenna conductor 112 through the roof 106, without making the distance large between the first antenna conductor 101 and the second antenna conductor 112. In this specification, “one end” does not necessarily have to be an end of an element, and may tolerate a width of a value to a certain extent that does not impair the functions of each of the embodiments.

The shape of the passive conductor 111 is not limited to the shape of this embodiment. For example, the first passive element 201 does not necessarily have to intersect perpendicularly to the second passive element 202, and the first passive element 201 or the second passive element 202 or the passive conductor 111 as a whole may be inclined. In addition, as illustrated in FIG. 2B, a third passive element 210 and a loop forming element 211 may be provided on the first passive element 201 to form a loop shape. Similarly, the second passive element 202 may form a loop shape. Such configurations may generate more current having an inverted phase with respect to the current flowing through the roof 106. The first passive element 210 and the third passive element 210 may form a dual element configuration, by not providing the loop forming element 211.

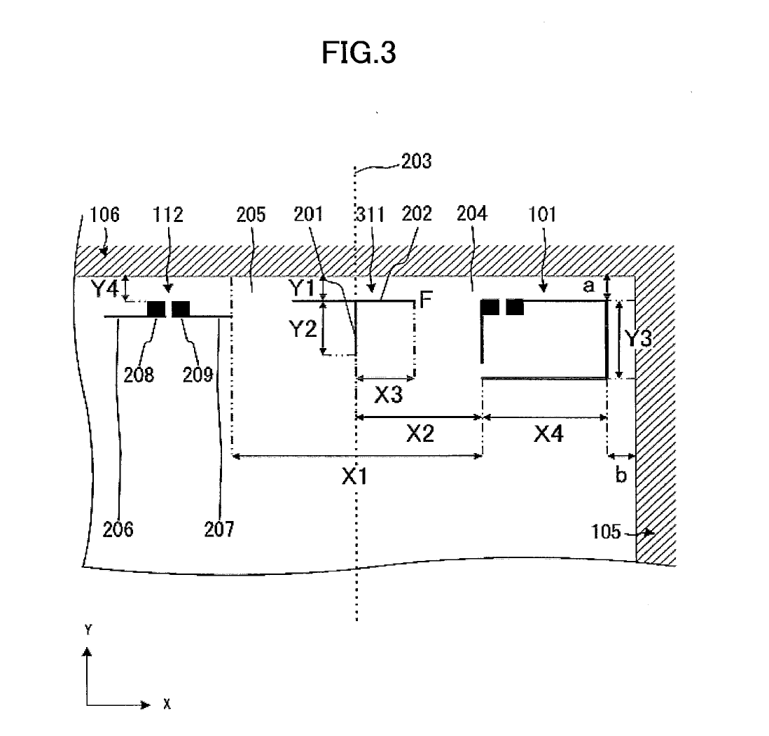

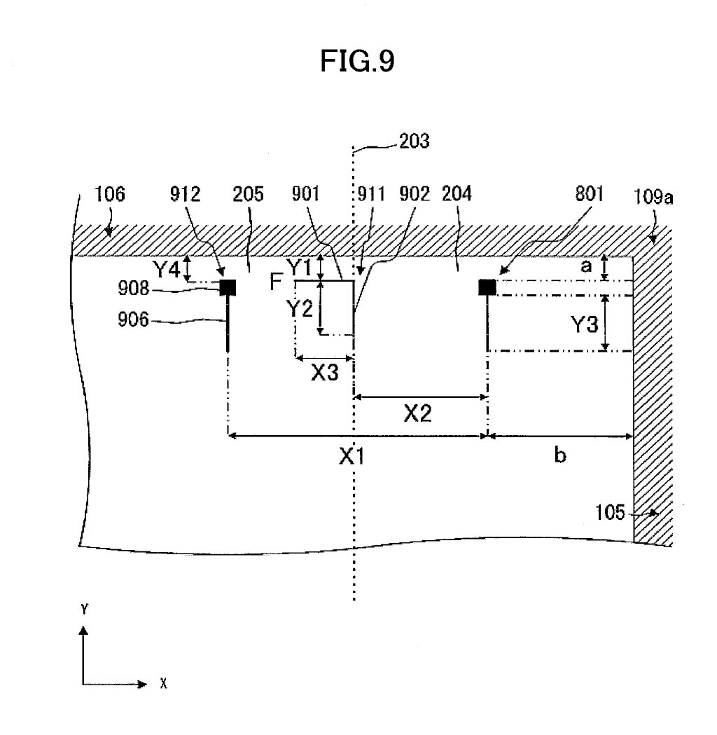

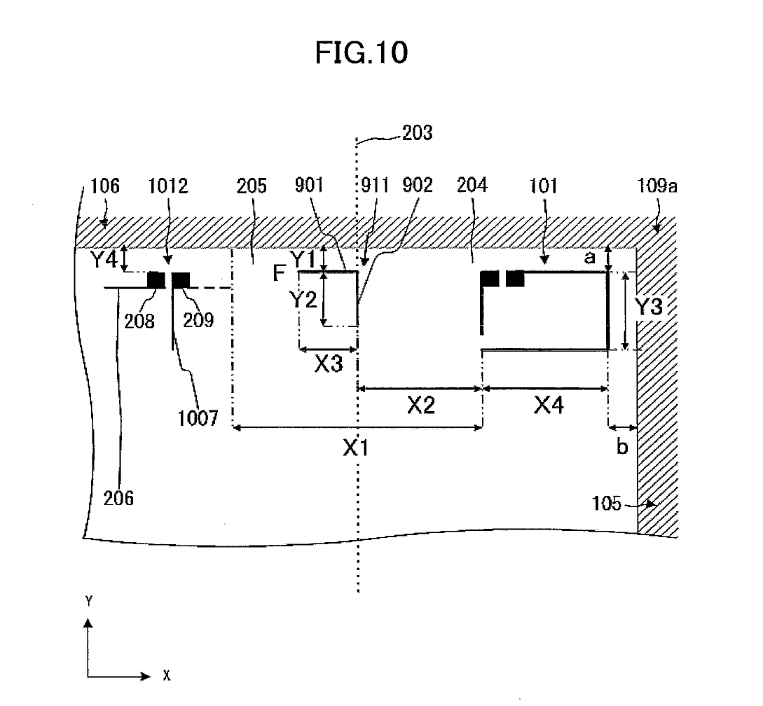

In addition, the first passive element 201 illustrated in FIG. 3 which will be described later may connect to an intermediate part of the second passive element 202 to form a T-shaped passive conductor 311. Further, as will be described later, the shape of the passive conductor in FIG. 2A may be inverted in the X-direction as illustrated in FIGS. 9 and 10, depending on the configuration of the second antenna conductor.

The automotive windshield glass 102 may be segmented into two, that is, a region 204 on the side of the first antenna conductor 101 and a region 205 on the side of the second antenna conductor 112, by an imaginary segmenting line 203 passing through the first passive element between the first antenna conductor 101 and the second antenna conductor 112. In this case, the second passive element 202 is desirably arranged in the region 204 on the side of the first antenna conductor 101 from a viewpoint of obtaining the interference reducing effect. More particularly, in the case in which the passive conductor 111 has the L-shape as illustrated in FIG. 2A, an open end F of the end part of the second passive element 202, not connected to the first passive element, is located in the region 204 on the side of the first antenna conductor 101 (this shape is hereinafter referred to as “L-shape”). Hence, when the excitation current is generated in the roof 106, and the L-shape open end F is located in the region 204, on the side of the first antenna conductor 101, where the current is easily transmitted through the roof 106, a current having an inverted phase with respect to the current flowing through the roof 106 can be generated in the second passive element 202. By connecting the second passive element 202 to the roof 106, it is possible to reduce the interference from the first antenna conductor 101 transmitted through the roof 106 to the second antenna conductor 112. The passive conductor 111 merely needs to generate the current having the inverted phase with respect to the current flowing through the roof 106 by locating the open end F in the region 204 on the side of the first antenna conductor 101, and an attached element may be provided on the open end F.

In the case of the passive conductor 311 having the T-shape as illustrated in FIG. 3, a current having an inverted phase with respect to the current flowing through the roof 106 may be generated in a horizontal part of the second passive element arranged on the side of the region 204. By connecting the horizontal part of the second passive element to the roof 106, it is possible to reduce the interference from the first antenna conductor 101 transmitted through the roof 106 to the second antenna conductor 112. As long as the open end F of the passive conductor 311 is located in the region 204 on the side of the first antenna conductor 101, any attached element may be provided in the region 205 on the side of the second antenna conductor 112.

In addition, from a viewpoint of more effectively obtaining the interference reducing effect, a conductor length from the other end of the first passive element on the side farther away from the horizontal conductor to the end part of the second passive element located on the side of the first antenna conductor is desirably in a range greater than or equal to 0.95λ_{g} and less than or equal to 1.2λ_{g}, where a wavelength in air at a center frequency of a predetermined frequency band in which the transmission and reception is made by the first antenna conductor is denoted by λ₀, a wavelength shortening coefficient of the automotive windshield glass is denoted by k, and a wavelength on the automotive windshield glass is denoted by λ_{q}=λ₀·k. More particularly, in the case of the L-shape illustrated in FIG. 2A, an overall length of the L-shaped part formed by the horizontal part formed by the second passive element 202 and the vertical part formed by the first passive element, that is, a sum of the lengths X3 and Y2 in FIG. 2A, is preferably greater than or equal to 0.95λ_{g} and less than or equal to 1.2λ_{g}. For example, in the case in which the ITS having the center frequency of 760 MHz is considered, the sum of the lengths X3 and Y2 is preferably greater than or equal to 120 mm and less than or equal to 152 mm. In addition, in the case of the T-shaped passive conductor 311 illustrated in FIG. 3, an overall length of the L-shaped part refers to the length (sum of the lengths X3 and Y2) of the L-shaped part formed by the horizontal part formed by the part of the second passive element on the side of the region 204 on the side of the first antenna conductor, and the vertical part formed by the first passive element 201.

Moreover, a value obtained by dividing the length X3 of the horizontal part of the second passive element 202 arranged in the region on the side of the first antenna conductor by the length Y2 of the first passive element is preferably greater than or equal to 0.2 and less than or equal to 1.3. The value obtained by dividing the length X3 of the horizontal part by the length Y2 of first passive element is more preferably greater than or equal to 0.4 and less than or equal to 1.2.

The passive conductor 111 is desirably provided at a position within a range in which a value obtained by dividing the minimum distance X1 between the first antenna conductor 101 and the second antenna conductor 112 by the minimum distance X2 between the first antenna conductor and the first passive element 201 is greater than or equal to 0.4 and less than or equal to 0.9.

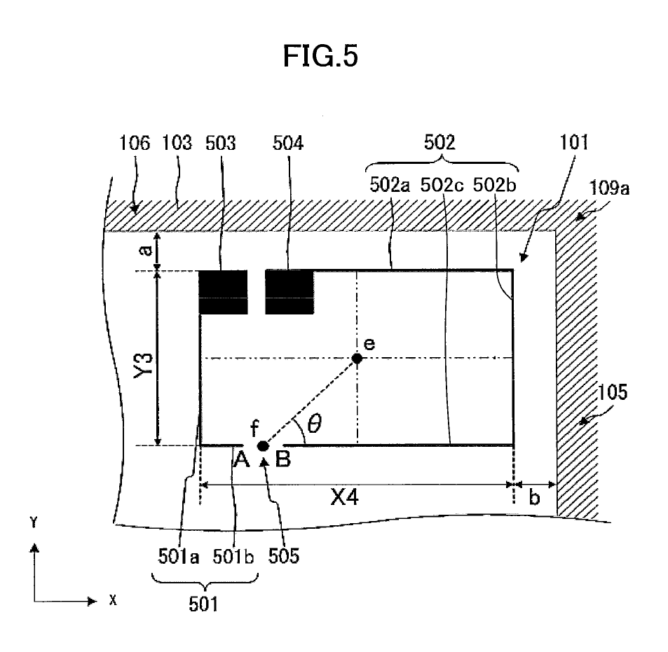

FIG. 5 is a partially enlarged view of one example of the first antenna conductor 101 of the antenna device in this embodiment. The first antenna conductor 101 includes a first feeding point, a first element 501, and a second element 502, and the first feeding point includes a first feeding part 503 and a second feeding part 504. The first antenna conductor 101 forms an antenna in which an excitation current is generated in the roof 106 and the current is transmitted through the roof 106.

One end of the first element 501 is connected to the first feeding part 503, and includes a partial element 501a extending downwardly, and a partial element 501b extending in a rightward direction from a starting point using a terminating part of the partial element 501a as the starting point. The partial element 501b extends to a terminating end A of the extension of the first element 501. In a case in which the terminating end A is provided at an intermediate point of the partial element 501a, the partial element 501b may be omitted.

In this embodiment, the length of the first element 501 is in a range greater than or equal to 0.2λ_{g} and less than or equal to 0.35λ_{g}, where the wavelength in air at the center frequency of the predetermined frequency band in which the transmission and reception is made by the first antenna conductor is denoted by λ₀, the wavelength shortening coefficient of the automotive windshield glass 102 is denoted by k, and the wavelength on the automotive windshield glass 102 is denoted by λ_{g}=λ₀·k.

For example, in a case in which the ITS is set as the predetermined frequency, the center frequency of the ITS is 760 MHz. Accordingly, in order to improve the antenna gain of the ITS, the length of the first element 501 is desirably greater than or equal to 50 mm and less than or equal to 89 mm, when the velocity of the radio wave is 3.0×10⁸ m/s and the wavelength shortening coefficient k is 0.64.

The second element 502 has one end connected to the second feeding part 504, and includes a partial element 502a extending in the rightward direction, a partial element 502b extending downwardly from a starting point using a terminating part of the partial element 502a as the starting point, and a partial element 502c extending in a leftward direction from a starting point using a terminating part of the partial element 502b as the starting point. The partial element 502c extends to a terminating end B of the second element 502.

The first feeding point is located at a part of the first antenna conductor 101 along the roof 106, that is, at the element of the first antenna conductor 101 on the side closer to the roof 106 and along the roof 106. In FIG. 5, the first feeding point is provided on an extension along the roof 106, including the partial element 502a. The second feeding part 504 is arranged on the side closer to the pillar 105 than the first feeding part 503.

The first element 501 and the second element 502 are arranged so that the terminating end A at the other end of the first element 501 and the terminating end B at the other end of the second element 502 are adjacent to each other. A cutout part 505 is formed between the terminating end A and the terminating end B. Accordingly, the entire shape of the first antenna conductor 101 is a semi-loop shape having the cutout part 505 at a part of the loop shape. Thereafter, in a case in which the first element 501 and the second element 502 are regarded as a single element, the first and second elements 501 and 502 in this case will be referred to as “semi-loop element”.

The partial element 501a forms a left side part of the semi-loop element, and the partial element 501b forms a part of a lower side part of the semi-loop element. On the other hand, the partial element 502a forms an upper side part of the semi-loop element to extend along the roof 106, the partial element 502b forms a right side part of the semi-loop element to extend along the pillar 105, and the partial element 502c forms a part of the lower side part of the semi-loop element.

In this embodiment, the terminating end A of the first element 501 and the terminating end B of the second element 502 exist at the same Y-coordinate, however, the locations of the terminating ends A and B are not limited to those of this embodiment. In other words, the terminating ends A and B may exist at different Y-coordinates, and the entire shape of the first antenna conductor 101 may be a semi-loop shape with a stepped part.

In a case in which a corner part of the metal flange 103 has an arcuate shape, the connecting part between the partial element 502a and the partial element 502b may have an arcuate shape matching the arcuate shape of the corner part of the metal flange 103.

Although the entire shape of the first antenna conductor 101 in this embodiment has an oblong semi-loop shape, the entire shape of the first antenna conductor 101 is not limited to that of this embodiment. The semi-loop element may have a parallelogram shape, a trapezoidal shape, a square shape, a circular shape, a polygon shape, or a fan-shape. Particularly, the partial element 501a and the partial element 502b may be formed parallel to or approximately parallel to the pillar 105, and the partial element 501b and the partial element 502c may be formed parallel to or approximately parallel to the roof 106.

The cutout part 505 separates the terminating end A of the first element 501 and the terminating end B of the second element 502, so that there is substantially no electrical connection between the first element 501 and the second element 502. Substantially no electrical connection not only refers to a case in which there is no DC coupling, but also refers to a case in which there is no AC coupling at an operating frequency of the first antenna conductor 101. For example, even when the semi-loop element is shaped such that the partial element 501b and the partial element 502c are separated in the Y-direction and overlap at the cutout part 505, there is substantially no electrical connection in a case in which a length of the overlapping part is insufficient to generate a high-frequency conduction state between the first element 501 and the second element 502. In this embodiment, the length of the overlapping part is desirably 0.04λ_{g} or less. For example, in the case in which the ITS having the center frequency of 760 MHz is considered, the length of the overlapping part is desirably less than 10 mm.

The cutout part 505 is provided at a position on a side opposite to the roof 106 with respect to an imaginary horizontal line passing through a center point e of a region surrounded by the semi-loop element, and on a side opposite to the pillar 105 with respect to an imaginary vertical line passing through the center point e. Further, the cutout part 505 is preferably provided at the position such that an angle (hereinafter referred to as “angle at which the cutout part 505 is provided”) formed by a straight line connecting the center point e and an intermediate point f of the cutout part 505 and a horizontal line parallel to the X-axis is in a range greater than or equal to 20° and less than or equal to 75°, and more preferably in a range greater than or equal to 30° and less than or equal to 65°. The angle at which the cutout part 205 is provided is furthermore preferably in a range greater than or equal to 35° and less than or equal to 60°. The center point e of the region surrounded by the semi-loop element refers to a center of gravity of the loop shape that omits the cutout part 505 of the semi-loop element. The intermediate point f of the cutout part 505 refers to a middle point of a straight line connecting the terminating end A of the first element 501 and the terminating end B of the second element 502.

In this embodiment, the cutout part 505 is provided at the lower side of the semi-loop element, however, the location of the cutout part 505 is not limited to that of this embodiment. In other words, depending on the angle at which the cutout part 505 is provided and an aspect ratio (a value obtained by dividing a height of the semi-loop element in the vertical direction by a width of the semi-loop element in the horizontal direction) of the semi-loop element, the cutout part 505 may be provided at a position including a lower left vertex of the semi-loop element, or at a left side of the semi-loop element.

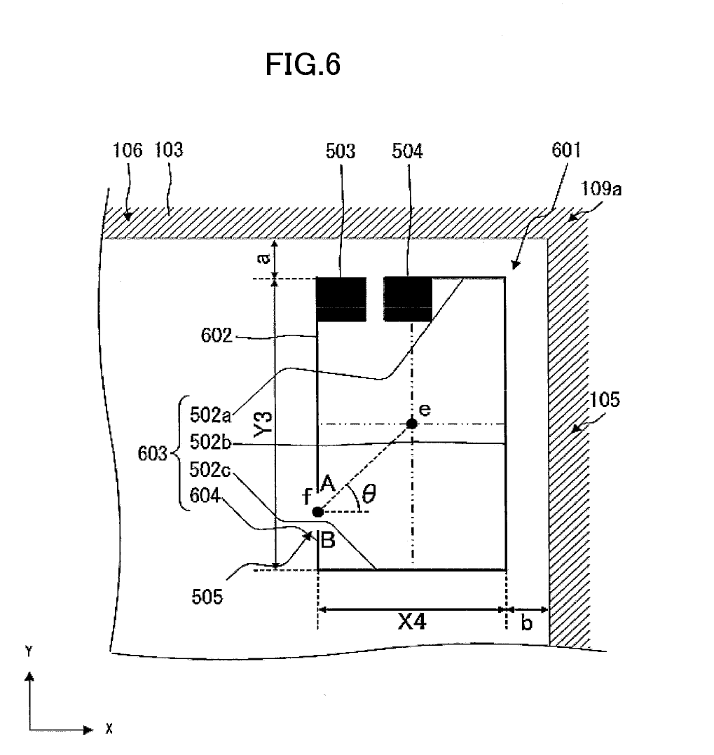

FIG. 6 illustrates an example in which the aspect ratio of the semi-loop element is varied, without varying the distance from the roof 106 to a first antenna conductor 601, the distance from the pillar 105 to the first antenna conductor 601, the angle at which the cutout part 505 is provided, the entire length of the semi-loop element, the position of the feeding point, and the length of a first element 602. Depending on the aspect ratio of the semi-loop element and the angle at which the cutout part 505 is provided, the partial element 501b may be omitted. In addition, a second element 603 includes a partial element 604 extending upwards from the terminating part of the partial element 502c. Depending on the angle at which the cutout part 505 is provided, the partial element 604 may be provided. Further, although a terminating end A of the first element 602 and a terminating end B of the second element 603 exist at the same X-coordinate in FIG. 6, however, the terminating ends A and B may exist at different X-coordinates, and the entire shape of the first antenna conductor 601 may be a semi-loop shape with a stepped part.

A length of the cutout part 505 is not limited to a particular value as long as the first element 501 and the second element 502 make no direct connection, however, is preferably 0.1 mm to 5 mm. The length of the cutout part 505 refers to a gap at a part where the first element 501 and the second element 502 are closest to each other at the cutout part 505. In FIG. 5, the length of the cutout part 505 corresponds to a length of the straight line connecting the terminating end A of the first element 501 and the terminating end B of the second element 502.

The first feeding part 503 and the second feeding part 504 are parts for electrically connecting the first antenna conductor 101 to a signal processing circuit that is not illustrated, such as an amplifier or the like, via a predetermined conductive member. For example, a feeder line, such as a coaxial cable or the like, may be used as the conductive member. In a case in which the coaxial cable is used, an inner conductor of the coaxial cable may be electrically connected to one of the first feeding part 503 and the second feeding part 504, and an outer conductor part of the coaxial cable may be electrically connected to the other of the first feeding part 503 and the second feeding part 504. In addition, a configuration may be employed in which a connector for electrically connecting the signal processing circuit, such as the amplifier or the like, to the feeding point is mounted at the feeding point. The coaxial cable can be mounted on the feeding point with ease using such a connector. Moreover, a configuration may be employed in which a conductive member having a projection shape is provided at the feeding point, and the conductive member having the projection shape makes contact with and/or is fitted into the connecting part that is provided on the metal flange 103 of the vehicle mounted with the automotive windshield glass 102. A part of or the entire feeding point may be provided in a peripheral region that includes the black concealing layer 104.

The first feeding part 503 and the second feeding part 504 are arranged adjacent to each other. The first feeding part 503 is provided in a vicinity of an upper left corner part of the first antenna conductor 101. As described above, because the length of the first element 501 and the position of the cutout part 505 fall within predetermined ranges, respectively, the position of the first feeding part 503 is consequently determined by the length of the first element 501 and the position of the cutout part 505.

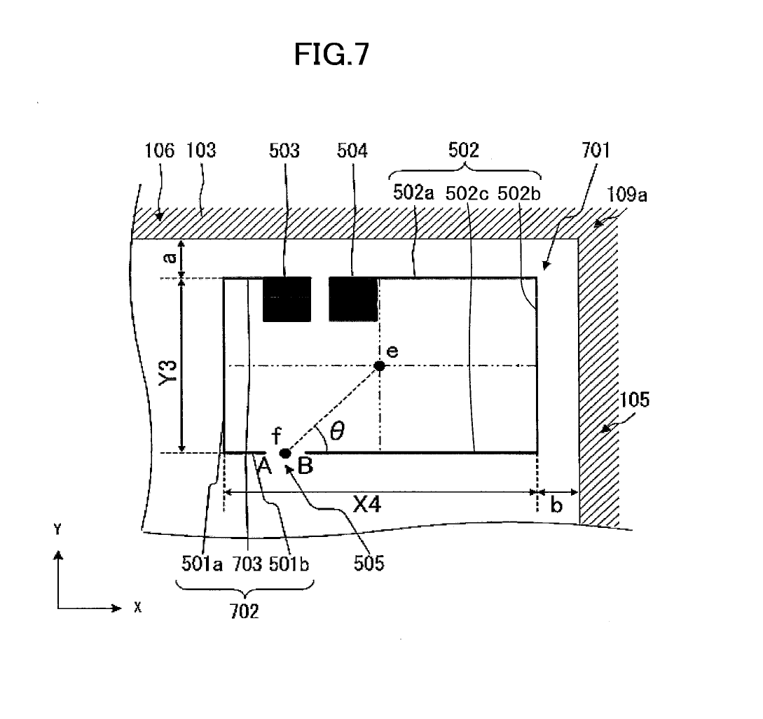

FIG. 7 illustrates an example in which the length of a first element 702 is extended and the position of the feeding point is made different, without varying the distance from the roof 106 to a first antenna conductor 701, the distance from the pillar 105 to the first antenna conductor 701, the angle at which the cutout part 505 is provided, the aspect ratio of the semi-loop element, and the entire length of the semi-loop element. As illustrated, the partial element 501a is not directly connected to the first feeding part 503, and is connected to the first feeding part 503 through an attached element 703. In this case, a combination of the attached element 703, the partial element 501a, and the partial element 501b may be regarded as a first element 702, and an overall length of the first element 702 is a sum of the lengths of each of the attached element 703, the partial element 501a, and the partial element 501b. As described above, the length of the first element and the position of the cutout part 505 fall within the predetermined ranges, and depending on the values, the position of the first feeding part 503 does not necessarily have to be the upper left corner part. However, in order to enable the roof-feeding, it is assumed that the first feeding part 503 is positioned at the upper side of the first antenna conductor 701, and that even in a case in which the length of the first element 702 is a minimum, the first feeding part 503 is positioned at the upper left corner part connecting the left side and the upper side.

In addition, in a case in which a height of the semi-loop element in the vertical direction is denoted by c, and a width of the semi-loop element in the horizontal direction is denoted by d, a sufficient communication performance can be obtained when the aspect ratio (c/d) that is obtained by dividing the height c by the width d of the semi-loop element is greater than or equal to 0.3. When the aspect ratio becomes less than 0.3, the lower side of the semi-loop element becomes adjacent to the first feeding part 503 or the second feeding part 504 or both, and it is not preferable in that a capacitive coupling may occur and the semi-loop element may be affected from the feeding point.

From a viewpoint of improving the communication performance, a circumference of the semi-loop element is desirably in a range of 1.05λ_{g} to 1.5λ_{g}, by assuming the semi-loop element to have an original loop shape having no gap between the first feeding part 503 and the second feeding part 504 of the feeding point for the first antenna conductor and no cutout part 505. In the following description, “circumference of the semi-loop element” refers to a length of the semi-loop element by assuming the semi-loop element to have the original loop shape having no gap between the first feeding part 503 and the second feeding part 504 of the feeding point for the first antenna conductor and no cutout part 505.

The second antenna conductor 112 includes a second feeding point, a third element 206, and a fourth element 207, and the second feeding point includes a third feeding part 208 and a fourth feeding part 209. The third feeding part 208 and the fourth feeding part 209 are parts for electrically connecting the second antenna conductor 112 to a signal processing circuit that is not illustrated, such as an amplifier or the like, via a predetermined conductive member, in a manner similar to the first feeding part 503 and the second feeding part 504.

In the first embodiment, the second antenna conductor 112 is a dipole type antenna, however, the antenna type of the second antenna conductor 112 is not limited to that of this embodiment. That is, the shape and the size of the antenna formed by the second antenna conductor 112 are not limited as long as the antenna can receive media different from but having a frequency close to the media receivable by the first antenna conductor 101. In addition, although the second antenna conductor 112 in FIG. 2A is provided at the same Y-coordinate as the first antenna conductor 101 and the passive conductor 111, however, the position of the second antenna conductor 112 is not limited to such an arrangement. The second antenna conductor 112 may be arranged at a position where the effects are notable within the range in which the interference transmitted from the first antenna conductor 101 through the roof 106, such as a position on the in-plane side of the glass than the first antenna conductor 101, for example.

Further, the conductor to which the first antenna conductor 101, the passive conductor 111, and the second antenna conductor 112 (hereinafter referred to as “three elements”) are adjacent is not limited to the horizontal conductor. In other words, a pattern in which the three elements are vertically arranged along the pillar 105 as illustrated in FIG. 2C is also acceptable, as long as the three elements are adjacent to the same conductor to which the three elements are electrically connected. The conductor in this case may be a plurality of electrically connected conductors that may be regarded as a single body, as illustrated in FIG. 1D. In a case in which the three elements are arranged along the vertical conductor, the passive conductor 111 includes the first passive element 201 that extends in the direction away from the vertical conductor, and the second passive element 202 that connects to the first passive element 201 and forms an L-shape.

The first and second antenna conductors, the first through fourth feeding parts, and the conductors may be formed by printing a paste including a conductive metal, such as silver paste or the like, on an inner surface of the automotive windshield glass 102 on the inner side of the vehicle, for example, and baking the printed paste. However, the method of forming the first and second antenna conductors, the first through fourth feeding parts, and the conductors is not limited to printing and baking the paste. For example, a wire-shaped member or a film-shaped member made of a conductive material, such as copper or the like, may be formed on the outer surface of the automotive windshield glass 102, bonded on the automotive windshield glass 102 by an adhesive or the like, or provided inside the automotive windshield glass 102 itself. In addition, a conductor layer including the antenna conductors may be provided inside or on a surface of a synthetic resin film, and this synthetic resin film including the conductor layer may be formed on the inner surface or the outer surface of the automotive windshield glass 102 to form the antenna conductors. Furthermore, a flexible printed circuit including the antenna conductors may be provided on the inner surface of the automotive windshield glass 102 to form the antenna conductors.

The shape of the first through fourth feeding parts may be determined according to the shape of the conductive member or a mounting surface of the connector. For example, from a practical viewpoint, the shape of the first through fourth feeding parts is preferably rectangular, including a square shape, an approximate square shape, a rectangular shape, an approximately rectangular shape, or the like, or a polygonal shape. The shape of the first through fourth feeding parts may also be circular, including a circular shape, an approximately circular shape, an oval shape, an approximately oval shape, or the like.

The automotive windshield glass 102 is not limited to glass plates, and may include a light transmission member such as a transparent resin plate, and a composite body of one or more glass plates and one or more transparent resin plates.

In this embodiment, the first antenna conductor 101 is provided at only one location of the automotive windshield glass 102. However, the first antenna conductor 101 may be provided at a plurality of locations on the same windshield glass, or provided on a plurality of windshield glass, and the plurality of first antenna conductors 101 may be used to form a multi-antenna system for diversity, MIMO, or the like. The communication performance can further be improved by forming the multi-antenna system.

### Second Embodiment

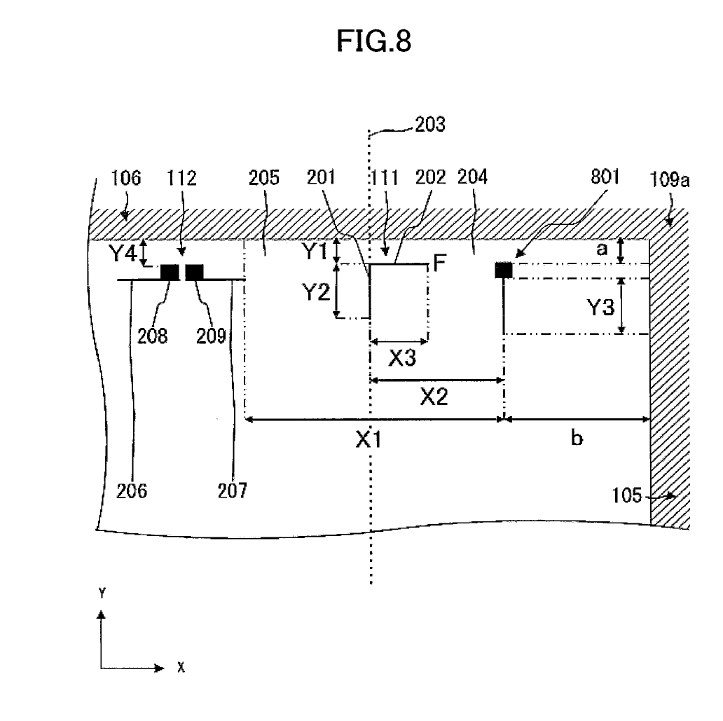

A first antenna conductor 801 of the antenna device in a second embodiment is a variation of the first antenna conductor 101 in the first embodiment, as illustrated in FIG. 8. In this second embodiment, the first antenna conductor differs from that of the first embodiment, however, other parts are the same as the first embodiment. For this reason, the same constituent parts are designated by the same reference numerals, and a description thereof will be omitted.

In the second embodiment, the first antenna conductor 801 is a monopole antenna having an element that is connected to one feeding part and extends in the vertical direction. The monopole antenna utilizes the roof 106 as the ground, and is configured to generate the excitation current in the roof 106 and transmit the current through the roof 106. For this reason, it is possible to reduce the interference from the first antenna conductor 801 transmitted to the second antenna conductor 112 through the roof 106. In addition, in the second embodiment, from the viewpoint of obtaining the interference reducing effect, it is desirable that the first passive element 201 connects to the left end of the second passive element 202 and the open end F is located in the region 204 on the side of the first antenna conductor to form an L-shape, as illustrated in FIG. 8.

As described above, the interference between the first antenna conductor 801, that is the monopole antenna, and the second antenna conductor 112, can be reduced by the passive conductor 111.

### Third Embodiment

A second antenna conductor 912 of the antenna device in a third embodiment is a variation of the second antenna conductor 112 in the second embodiment, as illustrated in FIG. 9. In this third embodiment, the open end F between the first antenna conductor 801 and the second antenna conductor 912 includes an L-shaped (hereinafter referred to as “inverted L-shaped”) passive conductor 911 in the region 205 on the side of the second antenna conductor. In this third embodiment, the second antenna conductor 912 and the passive conductor 911 differ from the second antenna conductor 112 and the passive conductor 111 of the second embodiment, however, other parts are the same as the second embodiment. For this reason, the same constituent parts are designated by the same reference numerals, and a description thereof will be omitted.

In the third embodiment, not only the first antenna conductor 801 but also the second antenna conductor 912 is a monopole antenna. The second antenna conductor 912 is configured to generate the excitation current in the roof 106 and transmit the current through the roof 106. For this reason, when the inverted L-shaped passive conductor 911 is provided as illustrated in FIG. 9, it is possible to reduce the interference from the second antenna conductor 912 transmitted to the first antenna conductor 801 through the roof 106.

In addition, as described above for the second embodiment, even in the case in which the passive conductor 911 has the L-shape, it is possible to reduce the interference from the first antenna conductor 801 transmitted to the second antenna conductor 912 through the roof 106. Because the first antenna conductor 801 is closer to the pillar 105 and generates a larger excitation current in the roof 106 and this larger current is transmitted to the second antenna conductor 912 through the roof 106, a larger interference reducing effect can be obtained in this embodiment when the passive conductor 911 has the L-shape.

### Fourth Embodiment

A second antenna conductor 1012 of the antenna device in a fourth embodiment is a variation of the second antenna conductor 112 in the first embodiment, as illustrated in FIG. 10. In this fourth embodiment, the fourth element 207 of the second antenna conductor 112 in the first embodiment extends in the vertical direction to form a vertical element 1007. In addition, the inverted L-shaped passive conductor 911 is provided between the first antenna conductor 101 and the second antenna conductor 1012. In this fourth embodiment, the second antenna conductor 1012 and the passive conductor 911 differ from the second antenna conductor 112 and the passive conductor 111 of the first embodiment, however, other parts are the same as the second embodiment. For this reason, the same constituent parts are designated by the same reference numerals, and a description thereof will be omitted.

The second antenna conductor 1012 in this fourth embodiment includes the third element 206 and the vertical element 1007, and form the L-shape as a whole. In FIG. 10, the vertical element 1007 extends from the inner side of the fourth feeding part 209, however, the vertical element 1007 may extend from any part of the fourth feeding part 209.

The second antenna conductor 1012 is located at a position such that the distance X1 between the first antenna conductor 101 and the second antenna conductor 1012 corresponds to that of the first embodiment. In other words, it is also assumed in this fourth embodiment that the fourth element 207 of the first embodiment is provided, and the distance X1 is regarded as the distance between the tip end of the fourth element 207 and a part of the first antenna conductor 101 closest to the second antenna conductor 1012.

The configuration of the second antenna conductor 1012 in this fourth embodiment generates a larger excitation current in the roof 106 and transmits the larger current to the first antenna conductor 101 through the roof 106, when compared to the second antenna conductor 112 in the first embodiment forming a horizontal dipole. For this reason, when the inverted L-shaped passive conductor 911 is provided as illustrated in FIG. 10, it is possible to reduce the interference from the second antenna conductor 1012 transmitted to the first antenna conductor 101 through the roof 106.

In addition, as described above as described above for the first embodiment, even in the case in which the passive conductor 911 has the L-shape, it is possible to reduce the interference from the first antenna conductor 101 transmitted to the second antenna conductor 1012 through the roof 106. Because the first antenna conductor 101 generates a larger excitation current in the roof 106 and this larger current is transmitted to the second antenna conductor 1012 through the roof 106, a larger interference reducing effect can be obtained in this embodiment when the passive conductor 911 has the L-shape.

Exemplary Implementations

<Shape of Passive Conductor>

A case is considered in which a conductor having a width of 40 mm surrounds a peripheral edge part of a rectangular glass substrate having a vertical length of 750 mm, a horizontal length of 1080 mm, and a thickness of 3.0 mm. Numerical computations are performed on a computer for this case to observe the effects of the passive conductor 111 in the first embodiment. The positions where the first antenna conductor 101, the second antenna conductor 112, and the passive conductor 111 are arranged are the same as those illustrated in FIG. 2A, and dimensions of each of the parts in units of mm are as follows.

a: 15

b: 10

X1: 205

X2: 112

X3: 68

X4: 85

Y1: 15

Y2: 68

Y3: 75

In addition, environmental conditions during the numerical computations are set as follows.

Angle at which cutout part 505 of first antenna conductor 101 is provided: 40°

Length of cutout part 505: 2 mm

Distance between first feeding part 503 and second feeding part 504: 5 mm

Distance between third feeding part 208 and fourth feeding part 209: 5 mm

Size of feeding part: 15 mm×15 mm

Distance Y4 between second antenna conductor 112 and roof 106: 15 mm

Length of third element 206: 65.5 mm

Length of Fourth element 207: 65.5 mm

Specific permittivity of glass plate: 7.0

Resistance of conductor: 0Ω

Thickness of each element and feeding point: 0.1 mm

Line width of each element: 1.0 mm

Normalized impedance: 50Ω

It is assumed that the third element 206 extends from the lower right end part of the third feeding part 208, and the fourth element 207 extends from the lower left end part of the fourth feeding part 209.

Numerical computations of attenuation characteristics (S21) are performed at 4 frequency points at 720 MHz, 740 MHz, 760 MHz, and 780 MHz for the antennas having the numerical values that are set in the above described manner, by an electromagnetic field simulation based on the FDTD (Finite-Difference Time-Domain) method. The S21 represents an intensity of the radio waves from the first antenna conductor 101 received by the second antenna conductor 112, and the smaller the value of S21, the smaller the effects, that is, the interference, of the first antenna conductor on the second antenna conductor.

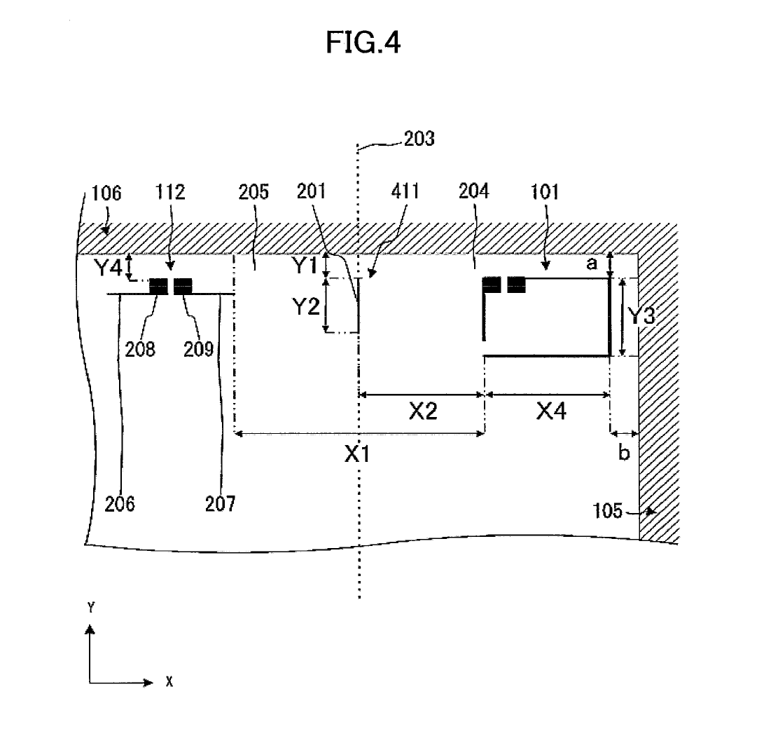

In addition to the passive conductor 111 having the L-shape illustrated in FIG. 2A, the analysis is also performed for the L-shape (inverted L-shape) in which the open end F is located in the region 205 on the side of the second antenna conductor, the T-shape illustrated in FIG. 3, and the linear shape illustrated in FIG. 4.

Table 1 illustrates simulation results for the S21 for a case in which the shape of the passive conductor 111 is varied in the first embodiment. The numeral values are computed at the frequencies of 720 MHz, 740 MHz, 760 MHz, and 780 MHz by considering the case in which the first antenna conductor 101 performs the transmission and reception of ITS having the center frequency of 760 MHz. In addition, in Table 1, Example 1 indicates the computation results for the case in which the passive conductor 111 has the linear shape, Example 2 indicates the computation results for the case in which the passive conductor 111 has the inverted L-shape, Example 3 indicates the computation results for the case in which the passive conductor 111 has the L-shape, and Example 4 indicates the computation results for the case in which the passive conductor 111 has the T-shape (hereinafter, Example 1 through Example 4 illustrated as keys indicate computation results obtained for similar shapes of the passive conductor 111, and Example 1 and Example 2 in Table 1 and Table 4 are comparison examples). Further, a difference between the S21 for the case in which the passive conductor 111 is not provided and the S21 for each of the Examples 1 through 4 is represented by “ΔS21”. In other words, the interference reducing effect is obtained when the ΔS21 in Table 1 has a negative value.

TABLE 1

| FREQUENCY | ΔS21 (dB) | | | |
|---|---|---|---|---|
| (MHz) | Example 1 | Example 2 | Example 3 | Example 4 |
| 720 | −1.94676 | 3.040764 | −6.25656 | −5.5585 |
| 740 | −2.12801 | 3.01245 | −12.505 | −8.5984 |
| 760 | −1.62029 | 3.557569 | −8.10189 | −4.15754 |
| 780 | −1.08342 | 3.272662 | −4.58196 | −2.33368 |

As may be seen from a comparison of the Examples 1 through 4, it is confirmed that mutual interference can be reduced by providing the L-shaped or T-shaped passive conductor between the first antenna conductor 101 and the second antenna conductor 112.

<Relationship Between Overall Length of Passive Conductor and S21>

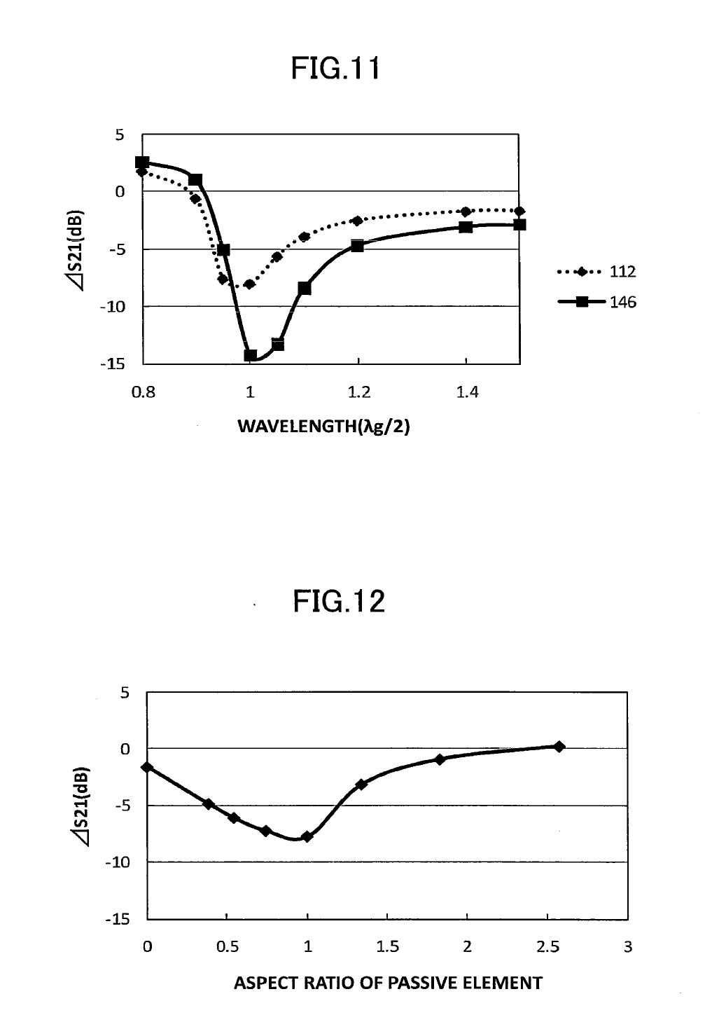

FIG. 11 is a graph illustrating simulation results of the S21 for a case in which the L-shaped passive conductor 111 is arranged between the first antenna conductor 101 and the second antenna conductor 112, and the overall length of the elements is varied in a state in which lengths of the first passive element 201 and the length of the second passive element 202 is 1:1. In FIG. 11, the abscissa indicates the length of the element normalized by λ_{g}/2. In addition, in FIG. 11, the value of ΔS21 on the ordinate indicates a difference of average values of S21 from 720 MHz to 780 MHz between the case in which no passive conductor is provided and each of the Examples (hereinafter, ΔS21 indicated on the graphs represents the same meaning). Hence, when ΔS21 has a negative value, it means that the interference reducing effect is obtained. Moreover, in FIG. 11, a key “112” indicates a case in which the distance X2 between the first antenna conductor and the first passive element 201 is 112 mm, and a key “146” indicates a case in which the distance X2 between the first antenna conductor and the first passive element 201 is 146 mm. The dimensions of each of the parts in units of mm are as follows.

a: 15

b: 10

X1: 205

X2: 112, 146

X3: 68

X4: 85

Y1: 15

Y2: 68

Y3: 75

Dimensions other than the above are the same as the previously described conditions.

From FIG. 11, it is confirmed that the overall length of the passive conductor is preferably in a range greater than or equal to 0.9(λ_{g}/2) and less than or equal to 1.5(λ_{g}/2), and more preferably in a range greater than or equal to 0.95(λ_{g}/2) and less than or equal to 1.2(λ_{g}/2) to obtain the interference reducing effect. For example, in the case in which the ITS having the center frequency of 760 MHz is considered, it is confirmed that the overall length of the passive conductor is preferably in a range greater than or equal to 113 mm and less than or equal to 190 mm, and more preferably in a range greater than or equal to 120 mm and less than or equal to 152 mm.

<Relationship Between Aspect Ratio of Passive Conductor and S21>

FIG. 12 is a graph illustrating simulation results of the S21 for a case in which the L-shaped passive conductor 111 is arranged between the first antenna conductor 101 and the second antenna conductor 112, and the overall length of the L-shape, that is, the sum of the lengths X3 and Y2 in FIG. 2A is 136 mm, and the aspect ratio of the passive conductor (value obtained by dividing the length X3 of the horizontal part by the length Y2 of the vertical part) is varied. In a case in which the aspect ratio of the passive conductor is 0, it is indicated that the passive conductor 111 has the linear shape. The dimensions of each of the parts in units of mm are as follows.

a: 15

b: 10

X1: 205

X2: 112

X3: 0, 38, 48, 58, 68, 78, 88, 98

X4: 85

Y1: 15

Y2: 136, 98, 88, 78, 68, 58, 48, 38

Y3: 75

Dimensions other than the above are the same as the previously described conditions of the numerical computations.

From FIG. 12, it is confirmed that the aspect ratio of the passive conductor is preferably in a range greater than or equal to 0 and less than or equal to 1.8, and more preferably in a range greater than or equal to 0.2 and less than or equal to 1.3, to obtain the interference reducing effect.

<Relationship Between X-Direction Position of Passive Conductor and S21>

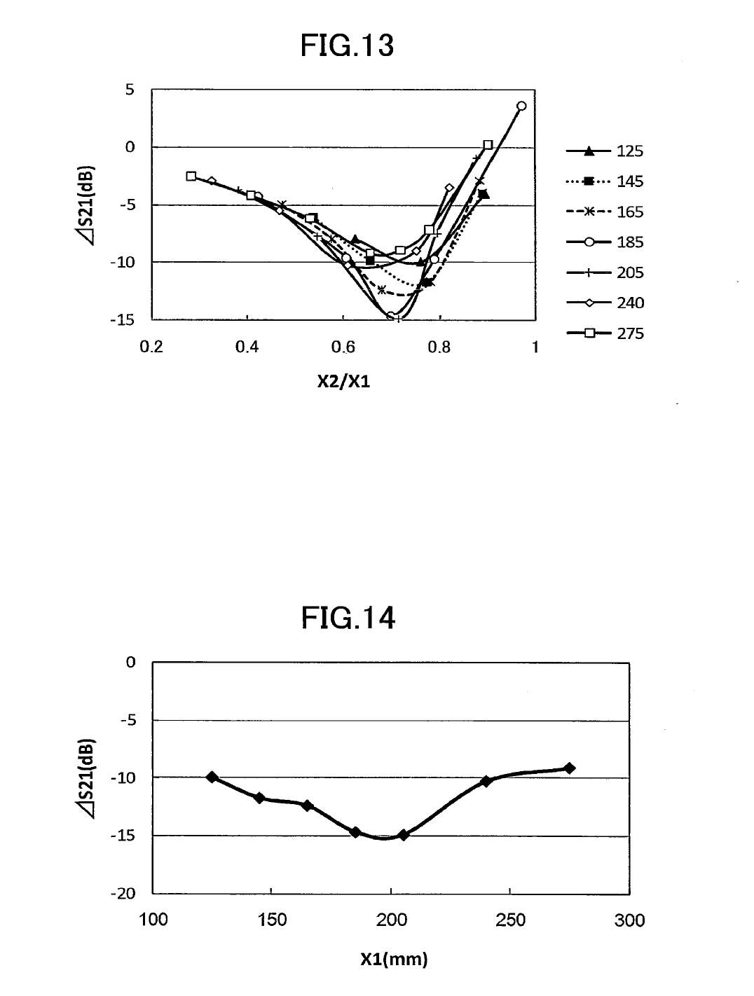

FIG. 13 is a graph illustrating simulation results of the S21 for a case in which the position of the L-shaped passive conductor 111 arranged between the first antenna conductor 101 and the second antenna conductor 112 is varied. In FIG. 13, the abscissa indicates a value (X2/X1) that is obtained by dividing the distance X2 between the first antenna conductor 101 and the passive conductor 111 by the distance X1 (hereinafter referred to as an inter-antenna distance X1) between the first antenna conductor 101 and the second antenna conductor. In addition, in FIG. 13, a numerical value of each key indicates the value (in units of mm) of the inter-antenna distance X1. The dimensions of each of the parts in units of mm are as follows, and it is assumed that X2 takes a value smaller than X1.

a: 15

b: 10

X1: 125, 145, 165, 185, 205, 240, 275

X2: 78, 95, 112, 129, 146, 163, 180, 197, 214, 248

X3: 68

X4: 85

Y1: 15

Y2: 68

Y3: 75

Dimensions other than the above are the same as the previously described conditions of the numerical computations.

From FIG. 13, it is confirmed that, regardless of the value of the inter-antenna distance X1, the value of X2/X1 is preferably in a range greater than or equal to 0.4 and less than or equal to 0.9, and more preferably in a range greater than or equal to 0.6 and less than or equal to 0.8, to obtain the interference reducing effect.

FIG. 14 is a graph illustrating simulation results in which the abscissa indicates the inter-antenna distance X1, and the ordinate indicates a maximum interference reducing amount due to the L-shaped passive conductor 111. From FIG. 14, it is confirmed that the inter-antenna distance X1 is preferably in a range greater than or equal to 0.6λ_{g} and less than or equal to 1λ_{g}, and more preferably in a range greater than or equal to 0.7λ_{g} and less than or equal to 0.9λ_{g}, to obtain the interference reducing effect. For example, in the case in which the ITS having the center frequency of 760 MHz is considered, it is confirmed that the inter-antenna distance X1 is preferably greater than or equal to 150 mm and less than or equal to 250 mm, and more preferably greater than or equal to 175 mm and less than or equal to 225 mm.

<Relationship Between Y-Direction Position of Passive Conductor and S21>

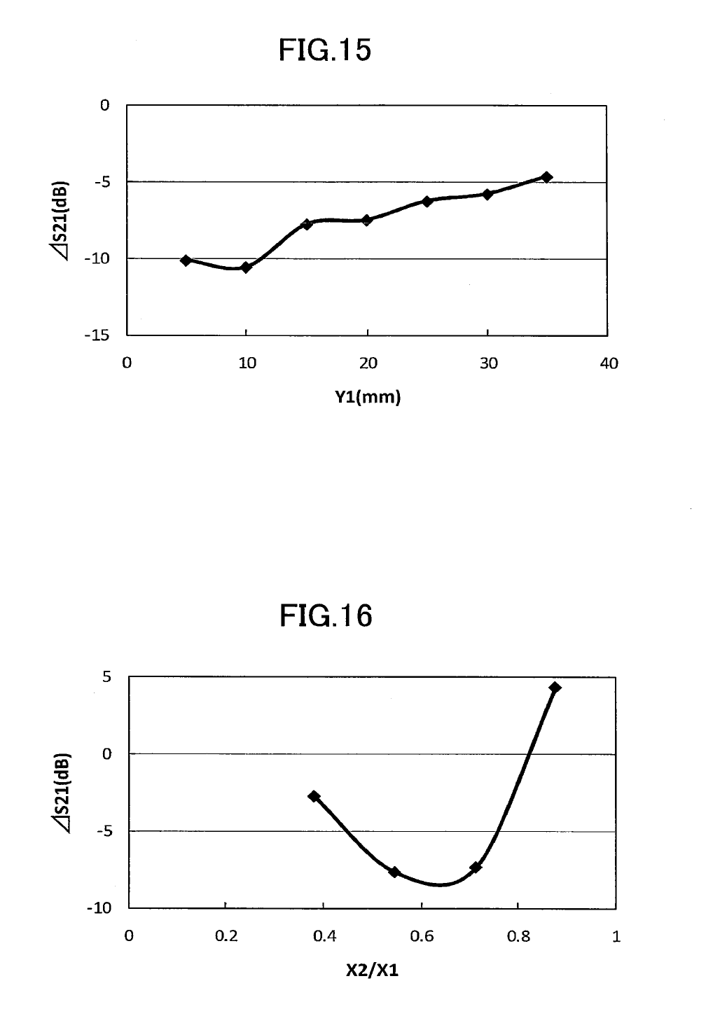

FIG. 15 is a graph illustrating simulation results of S21 for a case in which the distance Y1 between the passive conductor 111 and the roof 106 (horizontal conductor) is varied. The dimensions of each of the parts in units of mm are as follows.

a: 15

b: 10

X1: 205

X2: 112

X3: 68

X4: 85

Y2: 68

Y3: 75

Dimensions other than the above are the same as the previously described conditions of the numerical computations.

From FIG. 15, it is confirmed that, the closer the passive conductor 111 is to the roof 106, the greater the obtainable interference reducing effect. It is confirmed that the distance Y1 between the passive conductor 111 and the roof 106 (horizontal conductor) is preferably in a range greater than 0λ_{g} and less than or equal to 0.12λ_{g}. For example, in the case in which the ITS having the center frequency of 760 MHz is considered, it is confirmed that the distance Y1 is preferably greater than 0 mm and less than or equal to 30 mm, to obtain a large interference reducing effect. A lower limit of the distance Y1 is preferably a value that is as close as possible to 0λ_{g}.

<Relationship Between X-Direction Position of First Antenna Conductor and S21>

FIG. 16 is a graph illustrating the interference reducing effect of the passive conductor for a case in which the distance b of the first antenna conductor 101 from the pillar 105 is set large, and the first antenna conductor 101 is separated from the pillar 105. The dimensions of each of the parts in units of mm are as follows.

a: 15

b: 80

X1: 205

X2: 78, 112, 146, 180

X3: 68

X4: 85

Y1: 15

Y2: 68

Y3: 75

Dimensions other than the above are the same as the previously described conditions of the numerical computations.

From FIG. 16, it is confirmed that, even when the first antenna conductor 101 is located at a position separated from the pillar 105, a large interference reducing effect is obtained by providing the passive conductor 111 when the value of X2/X1 is greater than or equal to 0.4 and less than or equal to 0.85.

<Aspect Ratios of Passive Conductor and First Antenna Conductor>

Table 2 illustrates simulation results of S21 for a case in which the overall length of the first antenna conductor 101 is not changed, the height and the width are changed, and X4=55 mm, and Y3=105 mm. The dimensions of each of the parts in units of mm are as follows.

a: 15

b: 10

X1: 235

X2: 78, 112, 146, 180

X3: 68

X4: 55

Y1: 15

Y2: 68

Y3: 105

Dimensions other than the above are the same as the previously described conditions of the numerical computations.

In addition, in each example in Table 2, “78 mm”, “112 mm”, “146 mm”, and “180 mm” indicate the lengths of the distance X2 between the first antenna conductor and the first passive element 201.

TABLE 2

| FREQUENCY | ΔS21 (dB) | | | |
|---|---|---|---|---|
| (MHz) | 78 mm | 112 mm | 146 mm | 180 mm |
| 720 | −4.98803 | −9.49027 | −13.7358 | −21.4204 |
| 740 | −5.60897 | −7.77255 | −9.05243 | −17.0383 |
| 760 | −3.24643 | −4.63081 | −6.50977 | −17.9698 |
| 780 | −2.0134 | −2.47605 | −3.87914 | −10.8582 |

From Table 2, it is confirmed that the interference reducing effect is obtained in the simulation results for all cases of the distance X2.

Similarly, Table 3 illustrates simulation results of S21 for a case in which the overall length of the first antenna conductor 101 is not changed, the height and the width are changed, X4=115 mm, and Y3=45 mm. The dimensions of each of the parts in units of mm are as follows.

a: 15

b: 10

X1: 235

X2: 78, 112, 146

X3: 68

X4: 115

Y1: 15

Y2: 68

Y3: 45

Dimensions other than the above are the same as the previously described conditions of the numerical computations.

In addition, in each example in Table 3, “78 mm”, “112 mm”, and “146 mm” indicate the lengths of the distance X2 between the first antenna conductor 101 and the first passive element 201.

TABLE 3

| FREQUENCY | ΔS21 (dB) | | |
|---|---|---|---|
| (MHz) | 78 mm | 112 mm | 146 mm |
| 720 | 0.185131 | −2.39098 | −3.07151 |
| 740 | −3.05438 | −5.52029 | −2.95291 |
| 760 | −2.50025 | −7.2921 | −2.55263 |
| 780 | −1.37818 | −7.22118 | −2.04342 |

From Table 3, it is confirmed that the interference reducing effect is obtained in the simulation results for all cases of the distance X2. Accordingly, it is confirmed that, regardless of the aspect ratio of the first antenna conductor 101, it is possible to obtain the interference reducing effect by the provision of the passive conductor 111.

<Shapes of Passive Conductor and First Antenna Conductor>

Table 4 illustrates effects of the passive conductor 111 in the second embodiment. The dimensions of each of the parts in units of mm are as follows.

a: 5

b: 70

X1: 230

X2: 85

X3: 68

Y1: 5

Y2: 68

Y3: 53

Dimensions other than the above are the same as the previously described conditions of the numerical computations.

TABLE 4

| FREQUENCY | ΔS21 (dB) | | |
|---|---|---|---|
| (MHz) | Example 1 | Example 2 | Example 3 |
| 720 | −10.6099 | −10.0471 | −7.57353 |
| 740 | −10.7616 | −12.8737 | −14.6167 |
| 760 | −8.00234 | −8.46118 | −17.2892 |
| 780 | −6.31493 | −6.74848 | −11.2433 |

From Table 4, it is confirmed that performances are approximately the same in cases in which the passive conductor 111 has the inverted L-shape and the linear shape, but that a large interference reducing effect is obtained in a case in which the passive conductor 111 has the L-shape.

From the above results, it is confirmed that, regardless of the shape of the first antenna conductor 101, in a case in which the first antenna conductor 101 is configured to generate the excitation current in the roof 106 and transmit the current through the roof 106, the interference can be reduced by the L-shaped or T-shaped passive conductor.

<Shapes of Passive Conductor and Second Antenna Conductor>

Table 5 illustrates effects of the L-shaped passive conductor in the fourth embodiment. The dimensions of each of the parts in units of mm are as follows.

a: 15

b: 10

X1: 205

X2: 115

X3: 68

X4: 85

Y1: 15

Y2: 68

Y3: 75

The length of the vertical element 1007 is 65.5 mm. In addition, in each example in Table 5, “78 mm”, “112 mm”, “146 mm”, and “180 mm” indicate the lengths of the distance X2 between the first antenna conductor 101 and the first passive element 201.

TABLE 5

| FREQUENCY | ΔS21 (dB) | | | |
|---|---|---|---|---|
| (MHz) | 78 mm | 112 mm | 146 mm | 180 mm |
| 720 | −3.81236 | −6.12514 | −8.98919 | −9.57496 |
| 740 | −5.01927 | −8.43091 | −10.848 | −11.4688 |
| 760 | −2.69641 | −4.93946 | −6.94088 | −7.39611 |
| 780 | −1.91889 | −2.41105 | −2.95875 | −3.43457 |

From Table 5, it is confirmed that the interference reducing effect is obtained in the simulation results for all cases of the L-shaped passive conductor. In addition, it is confirmed that, regardless of the shape of the second antenna conductor, it is possible to obtain the interference reducing effect by the provision of the passive conductor 111.

Table 6 illustrates effects of the inverted L-shaped passive conductor in the fourth embodiment. The dimensions of each of the parts are the same as those of the case illustrated in Table 5.

TABLE 6

| FREQUENCY | ΔS21 (dB) | | | |
|---|---|---|---|---|
| (MHz) | 78 mm | 112 mm | 146 mm | 180 mm |
| 720 | −5.59785 | −7.89652 | −7.71088 | −3.63672 |
| 740 | −4.41083 | −5.54218 | −5.79892 | −3.11151 |
| 760 | −2.72976 | −4.07526 | −4.55433 | −2.44489 |
| 780 | −1.51762 | −2.11514 | −2.66169 | −1.25164 |

From Table 6, it is confirmed that the interference reducing effect is obtained in the simulation results for all cases of the inverted L-shaped passive conductor.

In addition, it is confirmed that the interference reducing effect can be obtained when the open end F of the second passive element of the passive conductor is located in the region on the side of the antenna conductor that is configured to easily transmit the excitation current generated in the roof 106 to the other antenna.

According to each of the embodiments described above, it is possible to provide an antenna device that can reduce the mutual interference in the case in which two antenna elements are arranged adjacent to the same conductor, such as the roof or the like.

The embodiments described above can provide an antenna device that can reduce mutual interference of the two antenna elements, and is suitable for use, for example, in a case in which the transmitting and receiving antenna for automotive inter-vehicle communication and the receiving antenna for the digital terrestrial television broadcast are provided on the same glass surface.

Although the embodiments are numbered with, for example, “first,” “second,” “third,” or “fourth,” the ordinal numbers do not imply priorities of the embodiments. Many other variations and modifications will be apparent to those skilled in the art.

What is claimed is:

1. An antenna device comprising:
a first antenna conductor having a first feeding point provided on windshield glass;
a second antenna conductor having a second feeding point;
a passive conductor; and
an auxiliary conductor, wherein
the first antenna conductor and the second antenna conductor are arranged in a vicinity of the auxiliary conductor with a predetermined gap therebetween,
the passive conductor includes a first passive element extending in a direction away from the auxiliary conductor, and a second passive element connected to one end of the first passive element on a side of the auxiliary conductor and extending along the auxiliary conductor, and
in a case in which the windshield glass is segmented into two regions by an imaginary segmenting line passing through the first passive element between the first antenna conductor and the second antenna conductor, an open end of the second passive element is arranged at a position on a side of the first antenna conductor, and adjacent to the auxiliary conductor between the first antenna conductor and the second antenna conductor.

2. The antenna device as claimed in claim 1, wherein the auxiliary conductor includes a horizontal conductor provided linearly in a horizontal direction.

3. The antenna device as claimed in claim 1, wherein the first antenna conductor is configured to generate an excitation current in the auxiliary conductor, and transmit the current through a roof.

4. The antenna device as claimed in claim 1, wherein the first antenna conductor and the second antenna conductor perform at least one of transmitting and receiving different media having frequencies that are close to each other.

5. The antenna device as claimed in claim 1, wherein a minimum distance between the passive conductor and the auxiliary conductor is greater than 0λ_{g} and less than or equal to 0.12λ_{g}, where a wavelength in air at a center frequency of a predetermined frequency band in which the first antenna conductor receives is denoted by λ₀, a wavelength shortening coefficient of the windshield glass is denoted by k, and a wavelength on the windshield glass is denoted by λ_{g}=λ₀·k.

6. The antenna device as claimed in claim 1, wherein a minimum distance between the passive conductor and the auxiliary conductor is greater than 0 mm and less than or equal to 30 mm.

7. The antenna device as claimed in claim 1, wherein the first antenna conductor includes at least an element extending in a direction away from the auxiliary conductor.

8. The antenna device as claimed in claim 1, wherein a conductor length of the first passive element from another end on a side farther away from the auxiliary conductor to an end part of the second passive element positioned on a side of the first antenna conductor is greater than or equal to 0.9(λ_{g}/2) and less than or equal to 1.5(λ_{g}/2), where a wavelength in air at a center frequency of a predetermined frequency band in which the first antenna conductor receives is denoted by λ₀, a wavelength shortening coefficient of the windshield glass is denoted by k, and a wavelength on the windshield glass is denoted by λ_{g}=λ₀·k.

9. The antenna device as claimed in claim 1, wherein a conductor length of the first passive element from another end on a side farther away from the auxiliary conductor to an end part of the second passive element positioned on a side of the first antenna conductor is greater than or equal to 113 mm and less than or equal to 190 mm.

10. The antenna device as claimed in claim 1, wherein a value that is obtained by dividing a length of a part of the second passive element arranged in a region on a side of the first antenna conductor by a length of the first passive element is greater than or equal to 0.2 and less than or equal to 1.3.

11. The antenna device as claimed in claim 1, wherein a minimum distance between the first antenna conductor and the second antenna conductor is greater than or equal to 0.6λ_{g} and less than or equal to 1λ_{g}, where a wavelength in air at a center frequency of a predetermined frequency band in which the first antenna conductor receives is denoted by λ₀, a wavelength shortening coefficient of the windshield glass is denoted by k, and a wavelength on the windshield glass is denoted by λ_{g}=λ₀·k.

12. The antenna device as claimed in claim 1, wherein a minimum distance between the first antenna conductor and the second antenna conductor is greater than or equal to 150 mm and less than or equal to 250 mm.

13. The antenna device as claimed in claim 1, wherein the passive conductor is arranged so that a value that is obtained by dividing a minimum distance between the first antenna conductor and the second antenna conductor by a minimum distance between the first antenna conductor and the first passive element is greater than or equal to 0.4 and less than or equal to 0.9.

14. The antenna device as claimed in claim 1, wherein
a feeding point for the first antenna conductor includes a first feeding part and a second feeding part that are arranged adjacent to each other,
the auxiliary conductor includes a horizontal conductor, and a vertical conductor that is electrically connected to the horizontal conductor and is provided linearly in a perpendicular direction,
the first antenna conductor includes a first element arranged in a vicinity of a connecting part of the horizontal conductor and the vertical conductor and having one end connected to the first feeding part, and a second element having one end connected to the second feeding part,
the first element and the second element form a semi-loop element having a cutout part, in a part of a loop shape, in a vicinity of another end of the first element and another end of the second element,
the cutout part is provided on a side opposite from the horizontal conductor with respect to an imaginary horizontal line passing through a center point of a region surrounded by the semi-loop element, and on a side opposite from the vertical conductor with respect to an imaginary vertical line passing through the center point, and
a length of the first element is greater than or equal to 0.2λ_{g} and less than or equal to 0.35λ_{g}, where a wavelength in air at a center frequency of a predetermined frequency band in which the first antenna conductor receives or transmits is denoted by λ₀, a wavelength shortening coefficient of the windshield glass is denoted by k, and a wavelength on the windshield glass is denoted by λ_{g}=λ₀·k.

15. The antenna device as claimed in claim 14, wherein the cutout part is provided at a position where an angle formed by a straight line connecting the center point and an intermediate point of the cutout part, and a horizontal line, is greater than or equal to 20° and less than or equal to 75°.
